(19) United States
(12) Patent Application Publication
(10) Pub. No.: US 2026/0285661 A1
(43) Pub. Date: Sep. 24, 2026

(54) EXTENDABLE BOOM WITH INCLUDED SAFETY MECHANISM AND METHOD OF USE

(71) Applicant: SHPAC USA, Inc., Harrisburg, PA (US)

(72) Inventor: Edwin ALICEA, Canfield, OH (US)

(73) Assignee: SHPAC USA, Inc., Harrisburg, PA (US)

(21) Appl. No.: 19/087,926

(22) Filed: Mar. 24, 2025

(51) Int. Cl. B66F 11/04; B66F 17/00

(52) U.S. Cl. CPC B66F 11/046; B66F 17/006

(57) ABSTRACT

An extendable boom for a lift vehicle and a method of operating the same. The extendable boom includes a lower boom that operably engages with the lift vehicle, an upper boom that slidably engages with and is housed inside of the lower boom, and a locking cylinder that is nested inside of the upper boom and is configured to transition the upper boom between an operating position and a stored position relative to the lower boom. In operation, the locking cylinder is configured to lock the upper boom to the stored position when the locking cylinder is free from being under load.

### TECHNICAL FIELD

This disclosure is generally directed to a cylinder having at least one latch mechanism. More specifically, this disclosure is directed to a hydraulic cylinder having at least one latch mechanism to lock the hydraulic cylinder when the hydraulic cylinder is free of hydraulic pressure.

### BACKGROUND ART

Mechanical actuators and cylinders are widely used in various applications due to their ability to convert energy into motion. Examples of suitable applications that utilize mechanical actuators and cylinders include industrial or manufacturing systems, automotive systems, robotics, and other various types of commercial applications. These mechanical cylinders may come in various types and use various types of mechanical loads or pressure to drive motion of actuation, including hydraulic pressure or fluid, air, or electrical energy. Each of these types of cylinders have advantages and disadvantages based on their intended use, including the complexity of the system or machine, the environment of use, or a range of generated force or power.

In one example, mechanical cylinders are commonly used in articulating booms or telescoping booms to assist workers or operators in reaching various locations above the ground surface to perform one or more aerial operations. These booms provide numerous advantageous in accessing “hard-to-reach” areas or locations that are extremely difficult to position an operator or person into to perform aerial operation with assistance from mechanical cylinders. As such, these booms provide maneuverability and versatility to operators in order to move around obstacles or to reach confined spaces to perform various tasks at aerial positions, including maintenance or utility work, construction tasks, or emergency responses.

While such articulating booms are essential in various maintenance, construction, and emergency industries, such articulating booms are prone to safety challenges when transporting such articulating booms between job sites or areas. In some cases, these articulating booms may be prone to expand or extend outwardly from associated lift vehicles that these booms are equipped to as the lift vehicles are traveling. With such issue, platforms or buckets that are attached to these booms may be actuate rearwardly causing the platforms or buckets to strike the ground surface or road or strike surrounding vehicles or pedestrians as the lift vehicles are traveling. Such issues arise when mechanical pressure, such as hydraulic fluid or air, is withdrawn and removed from these booms allowing one or more cylinders or actuators to freely move without operators controlling the actuation.

### SUMMARY OF THE INVENTION

As such, a device is needed for automatically securing actuations and cylinders when mechanical pressure or mechanical load is withdrawn from the actuations and cylinders. The presently disclosed locking cylinders include at least one latch mechanism that is configured to automatically lock inner and outer tubes with one another of these locking cylinders when mechanical pressure or mechanical load is removed and to automatically unlock inner and outer tubes from one another of these locking cylinders when mechanical pressure or mechanical load is exerted against such latch mechanism. The presently disclosed latch mechanisms are easily removable from bases of the locking cylinders or outer tubes of the locking cylinders for ease of repairing or replacing worn or damaged latch mechanisms with new and/or refurbished latch mechanisms.

In one aspect, an exemplary embodiment of the present disclosure may provide a locking cylinder. The locking cylinder includes an inner tube, an outer tube slideably engaged with the inner tube between a retracted position and an extended position, a base removably engaged with the outer tube and is in communication with the inner tube to partially receive the inner tube in the retracted position, and at least one latch mechanism operably engaged with the base inside of at least one locking passageway defined in the base. The at least one latch mechanism is configured to lock the inner tube with the base and the outer tube, collectively, at the retracted position.

This exemplary embodiment may further include that when the outer tube is in the retracted position, the at least one latch mechanism is free from being under load. This exemplary embodiment may further include that when the outer tube is in the extended position, the at least one latch mechanism is under load and is free from engaging with the inner tube. This exemplary embodiment may further include that the at least one latch mechanism further comprises: a piston moveably engageable inside the base between a locked position and an unlocked position relative to the inner tube; a biaser operably engaging with the piston to bias the piston to the locked position; and a retainer operably engaging with the biaser and the base and the outer tube for retaining the biaser and the piston inside of the base. This exemplary embodiment may further include that the piston comprises: a locking end operably engageable with the inner tube; a non-locking end opposite to the locking end and operably engages with the biaser; and a shoulder positioned between the locking end and the non-locking end to engage with the base when the piston locks the inner tube with the outer tube and base, collectively. This exemplary embodiment may further include that the non-locking end engages with and is housed inside of the biaser. This exemplary embodiment may further include that the piston further comprises: a cavity defined between the non-locking end and a base surface of the piston that is positioned between the locking end and the non-locking end and configured to engage with the biaser; wherein the cavity is configured to house a portion of the biaser. This exemplary embodiment may further include that the at least one latch mechanism further comprises: an annular channel defined in the piston at a position between the locking end and non-locking end; and a seal operably engaging with the piston inside of the annular channel and with an internal surface of the base inside of the at least one locking passageway. This exemplary embodiment may further include that the at least one latch mechanism further comprises: a first end of a latch plate operably engaging with the retainer; a second end of the latch plate operably engaging with the biaser; and a passage defined between the first end and the second end and is in fluid communication with the at least one locking passageway of the base. This exemplary embodiment may further include that the latch mechanism comprises: a piston moveably engageable inside the base between a locked position and an unlocked position relative to the inner tube; a first biaser operably engaging with the piston to bias the piston to the locked position; a second biaser operably engaging with the piston to bias the piston to the locked position and housed inside of the first biaser; and a retainer operably engaging with the first biaser, the second biaser, and the base for retaining the first biaser, the second biaser, and the piston inside of the base. This exemplary embodiment may further include that the inner tube comprises: a first end; a second end opposite to the first end and housed inside of the base when the outer tube and the base, collectively, are at the retracted position; an annular groove defined between the first end and the second end; and a ramp extending from the second end to the annular groove; wherein a piston of the at least one latch mechanism is configured to ride along the ramp and engage with the inner tube inside of the annular groove when the outer tube translates from the extended position to the retracted position. This exemplary embodiment may further include that when the outer tube is in the retracted position, the at least one latch mechanism is free from being under a hydraulic load; and wherein when the outer tube is in the extended position, the at least one latch mechanism is under the hydraulic load and is free from engaging with the inner tube.

In another aspect, an exemplary embodiment of the present disclosure may provide a method of locking a cylinder. The method includes steps of: drawing a load from an outer tube of the cylinder and from an inner tube of the cylinder; transitioning the outer tube from an extended position to a retracted position; receiving a portion of the inner tube by a base of the outer tube in the retracted position; extending a portion of at least one latch mechanism of the cylinder from the base and towards the inner tube; and locking the inner tube with the outer tube and the base, collectively, by the at least one latch mechanism at the retracted position, wherein the at least one latch mechanism is located inside of the base.

This exemplary embodiment may further include that when the outer tube is in the retracted position, the at least one latch mechanism is free from being under load. This exemplary embodiment may further include that when the outer tube is in the extended position, the at least one latch mechanism is under load and is free from engaging with the inner tube. This exemplary embodiment may further include steps of: sliding the at least one latch mechanism along a ramp of the inner tube as the outer tube transitions from the extended position to the retracted position; and seating a piston of the at one latch mechanism inside of a groove defined in the inner tube. This exemplary embodiment may further a step of biasing the piston of the at one latch mechanism into the groove by a biaser of the at least one latch mechanism when the at least one latch mechanism is free from being under load. This exemplary embodiment may further include a step of passing air through a retainer of the at least one latch mechanism and through the base when the outer tube moves between the retracted position and the extended position. This exemplary embodiment may further include that the at least one latch mechanism maintains the load inside of the outer tube and the base. This exemplary embodiment may further include that when the outer tube is in the retracted position, the at least one latch mechanism is free from being under a hydraulic load; and wherein when the outer tube is in the extended position, the at least one latch mechanism is under the hydraulic load and is free from engaging with the inner tube.

In yet another aspect, an exemplary embodiment of the present disclosure may provide an extendable boom for a lift vehicle. The extendable boom includes a lower boom operably engaged with the lift vehicle, an upper boom slidably engaged with and housed inside of the lower boom, and a locking cylinder nested inside of the upper boom configured to transition the upper boom between an operating position and a stored position relative to the lower boom. The locking cylinder is configured to lock the upper boom to the stored position when the locking cylinder is free from being under load.

This exemplary embodiment may further include that when the upper boom is in the stored position, at least one latch mechanism of the locking cylinder is free from being under the load exerted inside of the locking cylinder. This exemplary embodiment may further include that when the upper boom is in the operating position, at least one latch mechanism of the locking cylinder is under the load exerted inside of the locking cylinder and is free from engaging with an inner tube of the locking cylinder. This exemplary embodiment may further include that the locking cylinder comprises: an inner tube; an outer tube slideably engaged with the inner tube between a retracted position and an extended position; a base removably engaged with the outer tube and is in communication with the inner tube to partially receive the inner tube in the retracted position; and at least one latch mechanism is configured to lock the inner tube with the base and the outer tube, collectively, at the retracted position. This exemplary embodiment may further include that the at least one latch mechanism further comprises: a piston moveably engageable inside the base between a locked position and an unlocked position relative to the inner tube; a biaser operably engaging with the piston to bias the piston to the locked position; and a retainer operably engaging with the biaser and the base for retaining the biaser and the piston inside of the base. This exemplary embodiment may further include that the piston comprises: a locking end operably engageable with the inner tube; a non-locking end opposite to the locking end and operably engages with the biaser; and a shoulder positioned between the locking end and the non-locking end to engage with the base when the piston locks the inner tube with the outer tube and the base, collectively. This exemplary embodiment may further include that the non-locking end engages with and is housed inside of the biaser. This exemplary embodiment may further include that the piston further comprises: a cavity defined between the non-locking end and a base surface of the piston that is positioned between the locking end and the non-locking end and configured to engage with the biaser; wherein the cavity is configured to house a portion of the biaser. This exemplary embodiment may further include that the at least one latch mechanism further comprises: an annular channel defined in the piston at a position between the locking end and non-locking end; and a seal operably engaging with the piston inside of the annular channel and with an internal wall of the base inside of the at least one locking passageway. This exemplary embodiment may further include that the at least one latch mechanism further comprises: a first end of a latch plate operably engaging with the retainer; a second end of the latch plate operably engaging with the biaser; and a passage defined between the first end and the second end and is in fluid communication with the at least one locking passageway of the base. This exemplary embodiment may further include that the at least one latch mechanism comprises: a piston moveably engageable inside of the base between a locked position and an unlocked position relative to the inner tube; a first biaser operably engaging with the piston to bias the piston to the locked position; a second biaser operably engaging with the piston to bias the piston to the locked position and housed inside of the first biaser; and a retainer operably engaging with the first biaser, the second biaser, and the base for retaining the first biaser, the second biaser, and the piston inside of the base. This exemplary embodiment may further include that the inner tube comprises: a first end; a second end opposite to the first end and housed inside of the base when the outer tube and the base, collectively, are at the retracted position; an annular groove defined between the first end and the second end; and a ramp extending from the second end to the annular groove; wherein a piston of the at least one latch mechanism is configured to ride along the ramp and engage with the inner tube inside of the annular groove when the outer tube translates from the extended position to the retracted position. This exemplary embodiment may further include that when the outer tube is in the retracted position, the at least one latch mechanism is free from being under a hydraulic load; and wherein when the outer tube is in the extended position, the at least one latch mechanism is under the hydraulic load and is free from engaging with the inner tube.

In yet another aspect, an exemplary embodiment of the present disclosure may provide a method of operating an extendable boom for a lift vehicle. The method includes steps of: removing a load from a locking cylinder of the extendable boom; transitioning an upper boom of the extendable boom from an extended position to a retracted position relative to a lower boom of the extendable boom by the locking cylinder, wherein the locking cylinder is seated inside of the upper boom; locking the upper boom with the lower boom when the locking cylinder is free from being under load.

This exemplary embodiment may further include that the step of locking the upper boom with the lower boom further comprises: providing at least one latch mechanism of the locking cylinder with a base of the locking cylinder; and locking the at least one latch mechanism with an inner tube of the locking cylinder inside of a groove defined by the inner tube. This exemplary embodiment may further include that when the upper boom is in the extended position, the at least one latch mechanism is under load and is free from engaging with the inner tube of the locking cylinder. This exemplary embodiment may further include steps of: sliding at least one latch mechanism along a ramp of the inner tube as the outer tube transitions from the extended position to the retracted position; and seating a piston of the at one latch mechanism inside of a groove defined in the inner tube. This exemplary embodiment may further include a step of biasing the piston of the at one latch mechanism into the groove by a biaser of the at least one latch mechanism when the at least one latch mechanism is free from being under load. This exemplary embodiment may further include a step of passing air through a retainer of the at least one latch mechanism and through the base when the outer tube moves between the retracted position and the extended position. This exemplary embodiment may further include that the at least one latch mechanism maintains the load inside of the outer tube and the base.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of a lift vehicle equipped with an articulating boom having an extension boom and a locking cylinder in accordance with one aspect of the present disclosure.

FIG. 2 is a side elevation view of the locking cylinder diagrammatically illustrated in FIG. 1.

FIG. 3 is a partial longitudinal section view of the locking cylinder shown in FIG. 2.

FIG. 3A is an enlargement view of the highlighted region of the locking cylinder shown in FIG. 3.

FIG. 4 is a top perspective view of a piston of a latch mechanism of the locking cylinder.

FIG. 5 is a section view of the piston taken in direction of line 5-5 shown in FIG. 4.

FIG. 6A is an operational view of an outer tube of the locking cylinder moving from a retracted position to an extended position and each latch mechanism moving from a locked position to an unlocked position as a mechanical load is forced into the locking cylinder.

FIG. 6B is another operational view continuing from FIG. 6A, wherein each latch mechanism is in the unlocked position and the outer tube of the locking cylinder and a base of the locking cylinder are moving, collectively, towards the extended position.

FIG. 6C is enlargement view of the highlighted region of one of the latch mechanisms shown in FIG. 6B, wherein the hydraulic fluid moves the latch mechanism to the unlocked position and air provided in the latch mechanism is pressed outside of the locking cylinder.

FIG. 6D is another operational view continuing from FIG. 6B, wherein each latch mechanism is in the unlocked position and disengaged from the inner tube and the outer tube and base of the locking cylinder are moving, collectively, towards the extended position.

FIG. 7 is another operational view similar to FIG. 6D showing the upper boom and platform extending away from the lower boom due to the movement of the locking cylinder from the retracted position to the extended position.

FIG. 8A is an operational view of the outer tube and base of the locking cylinder moving, collectively, from the extended position to the retracted position and each latch mechanism moving from the unlocked position to the lock position as the mechanical load is withdrawn from the locking cylinder.

FIG. 8B is another operational view continuing from FIG. 8A, wherein each latch mechanism engages with the inner tube and rides along a first portion of a ramp of the inner tube in the locked position as the outer tube and base move to the retracted position.

FIG. 8C is another operational view continuing from FIG. 8B, wherein each latch mechanism engages with the inner tube and rides along a second portion of the ramp of the inner tube in the locked position as the outer tube and base move to the retracted position.

FIG. 8D is another operational view continuing from FIG. 8C, wherein each latch mechanism engages with and is seated inside of the inner tube in the locked position, and the outer tube and base are in the retracted position when the mechanical load is removed.

FIG. 9 is another operational view similar to FIG. 8D showing the upper boom substantially nested inside of the lower boom due to the movement of the locking cylinder from the extended position to the retracted position.

FIG. 10 is partial sectional view of a locking cylinder having a latch mechanism in accordance with a second aspect of the present disclosure.

FIG. 11 is a top perspective view of a piston of the latch mechanism shown in FIG. 10.

FIG. 12 is a sectional view of the piston of the latch mechanism taken in the direction of line 12-12 shown in FIG. 11.

FIG. 13 is partial sectional view of a locking cylinder having a latch mechanism in accordance with a third aspect of the present disclosure.

FIG. 14 is a top perspective view of a piston of the latch mechanism shown in FIG. 13.

FIG. 15 is a sectional view of the piston of the latch mechanism taken in the direction of line 15-15 shown in FIG. 14.

FIG. 16 is partial sectional view of a locking cylinder having a latch mechanism in accordance with a fourth aspect of the present disclosure.

FIG. 17 is partial sectional view of a locking cylinder having a latch mechanism in accordance with a fifth aspect of the present disclosure.

FIG. 18 is a side elevation view of a locking cylinder in accordance with a sixth aspect of the present disclosure.

FIG. 19A is a partial sectional view of the locking cylinder shown in FIG. 18, wherein the locking cylinder includes a latch mechanism in accordance with the sixth aspect of the present disclosure.

FIG. 19B is an operational view of the locking cylinder shown in FIG. 19A.

FIG. 20 is a diagrammatic flowchart for method of securing a cylinder.

FIG. 21 is a diagrammatic flowchart for method of operating an extendable boom for a lift vehicle.

Similar numbers refer to similar parts throughout the drawings.

### DETAILED DESCRIPTION

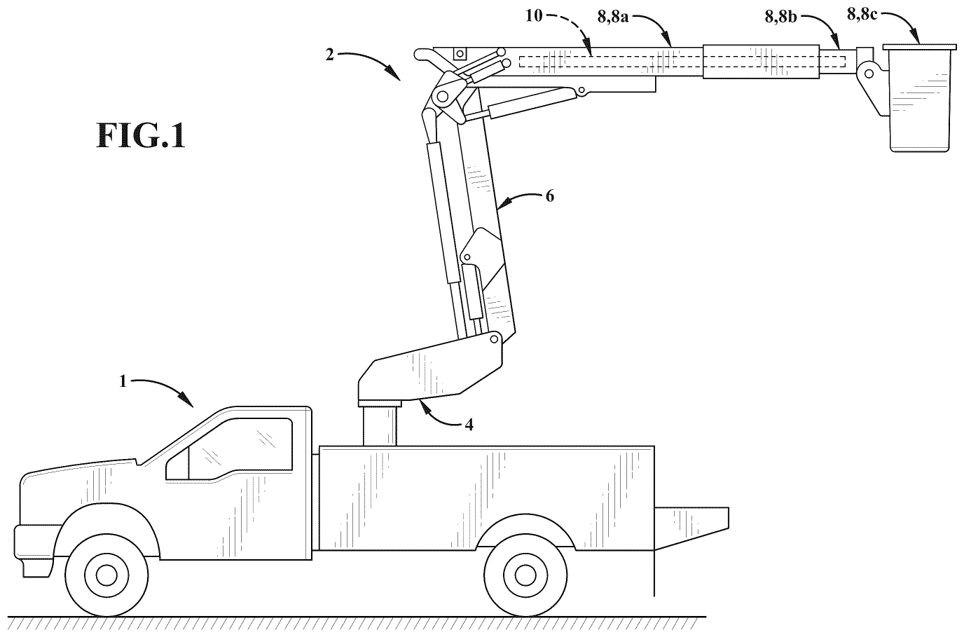

FIG. 1 illustrates a lift vehicle (generally referred to as numeral 1) that is equipped with an articulating boom (generally referred to as numeral 2) to perform various aerial operations or tasks that are difficult to access from ground level. Generally, articulating boom 2 includes a pedestal 4 that rotatably engages with the lift vehicle 1 to rotate the articulating boom 2 to a desired angle for reaching and performing aerial operations or tasks above the lift vehicle 1. Articulating boom 2 also includes a lifting arm 6 that pivotably engages with pedestal 4 to lift and/or elevate an extension boom 8 to a desired height above the lift vehicle 1.

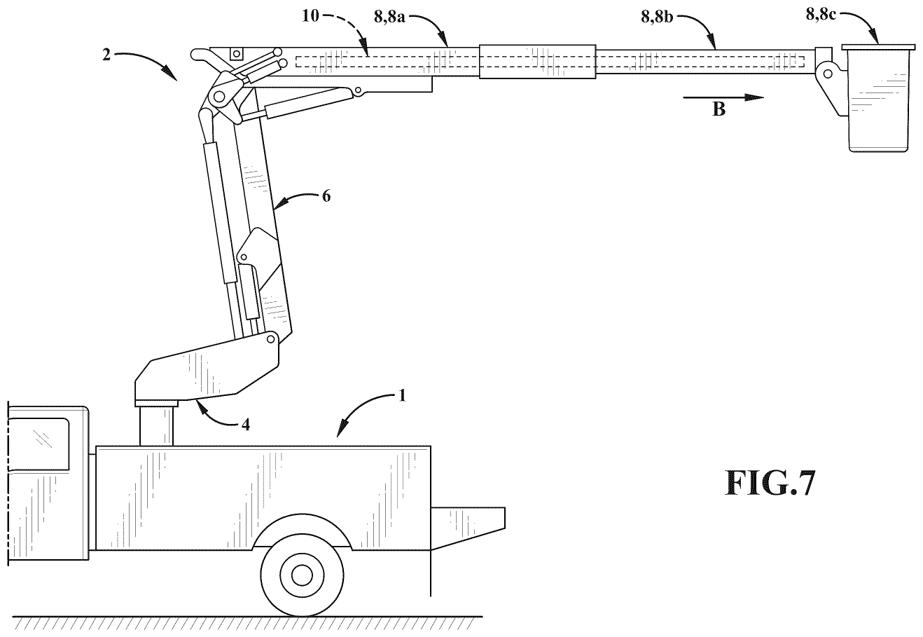

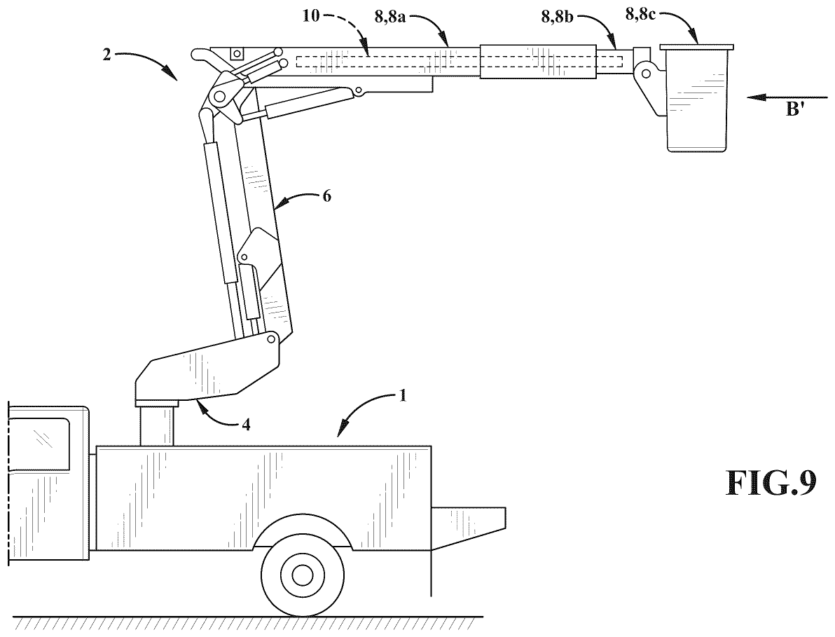

In FIG. 1, extension boom 8 of articulating boom 2 includes a first or lower boom 8a that pivotably engages with the lifting arm 6. It should be noted that lifting arm 6 may include further actuators or cylinders to vertically pivot lower boom 8a to a desired angle or height based on the height needed for an operator of articulating boom 2 to perform aerial operations or tasks. Extension boom 8 also includes a second or upper boom 8b that slidably engages with lower boom 8a and is partially nested inside of lower boom 8a. In operation, upper boom 8b is configured to move between a stored position (see FIGS. 1 and 9) and an operating position (see FIG. 7) along a longitudinal axis of extension boom 8 to reach a desired aerial position. Extension boom 8 also includes a platform or bucket 8c that is operably engaged with upper boom 8b. In operation, platform 8c is configured to support at least one operator of articulating boom 2 so that such operator may perform aerial operations or tasks above the lift vehicle 1 or ground surface.

Still referring to FIG. 1, articulating boom 2 also includes an extension cylinder or locking cylinder 10 that operably engages with the extension boom 8. In FIG. 1, locking cylinder 10 is housed and/or nested inside of the extension boom 8 to move the upper boom 8b and platform 8c between the stored position and the operating position. As discussed in greater detail below, locking cylinder 10 is configured to automatically lock the upper boom 8b and platform 8c at the stored position prior to a load (such as hydraulic fluid or other mechanical loads) being exerted on locking cylinder 10. Additionally, locking cylinder 10 is configured to automatically unlock the upper boom 8b and platform 8c from the stored position when a load (such as hydraulic fluid or other mechanical loads) is exerted on locking cylinder 10 to move the upper boom 8b and platform 8c to a desired operating position relative to the lower boom 8a.

In the present disclosure, lift vehicle 1 is shown as a cherry picker, bucket truck, or lift truck that is equipped with articulating boom 2 having locking cylinder 10. It should be understood that while a lift truck is illustrated as lift vehicle 1, other suitable vehicles or units may be used and be equipped with articulating boom 2 having locking cylinder 10. In one exemplary embodiment, a lift vehicle may be a stationary or towed vehicle that is equipped with articulating boom 2 having locking cylinder 10 or other locking cylinders mentioned herein. In another exemplary embodiment, a lift vehicle may be a moveable or drivable vehicle that is equipped with articulating boom 2 having locking cylinder 10 or other locking cylinders mentioned herein.

Further, while articulating boom 2 is shown in the present disclosure, other types of boom lifts may be fitted with locking cylinder 10. In one exemplary embodiment, a telescoping boom may be equipped to lift vehicle 1 and have the locking cylinder 10 or other locking cylinders discussed herein. In this exemplary embodiment, locking cylinder 10 may be equipped to at least two telescoping portions of telescoping boom for automatically locking said telescoping portions when the telescoping boom is in the stored position and is being transported by the vehicle and for automatically unlocking said telescoping portions when the telescoping boom is in the operating position and is being used to perform aerial operations.

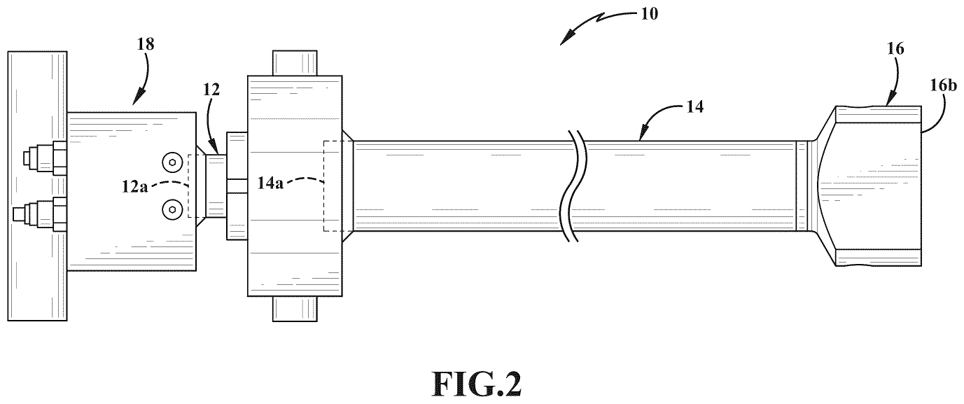

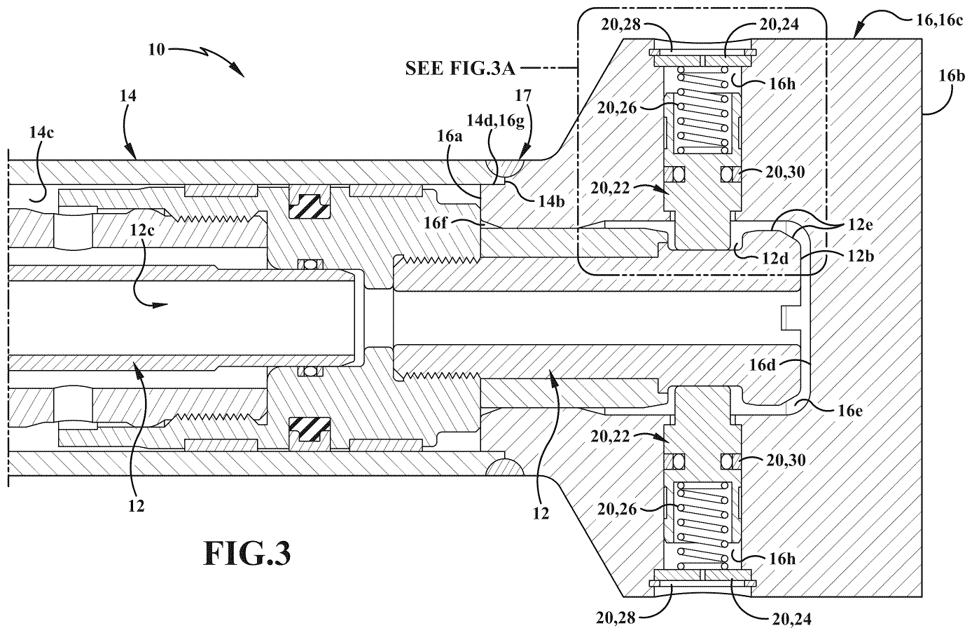

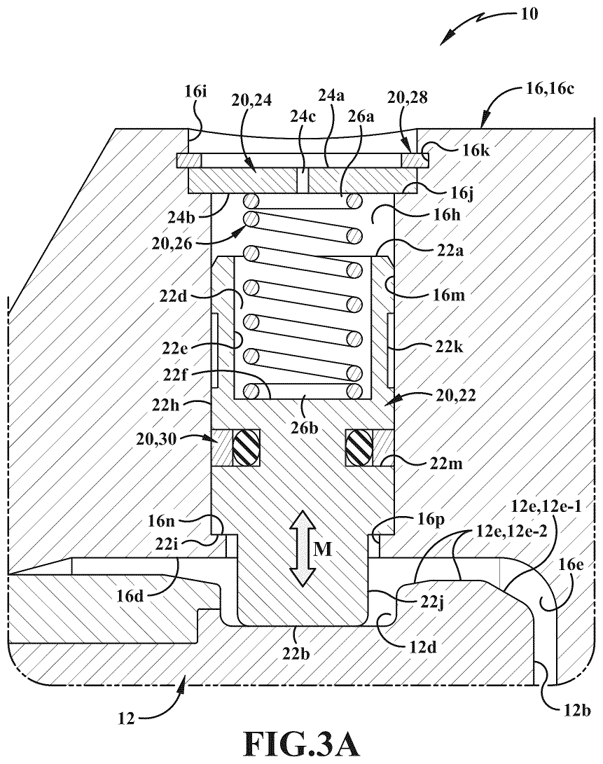

In FIGS. 2-3, locking cylinder 10 includes a first or inner tube 12. In the present disclosure, inner tube 12 includes a first end 12a, a second end 12b opposite to the first end 12a (see FIG. 3), and a longitudinal axis defined between the first end 12a and the second end 12b. Inner tube 12 also defines an inner passageway 12c that extends along the longitudinal axis of inner tube 12 between first end 12a and second end 12b; it should be noted that first end 12a and second end 12b are open ends and may access inner passageway 12c at either the first end 12a or second end 12b. Inner tube 12 also defines annular groove 12d that extends radially into the inner tube 12 at a location between the first end 12a and the second end 12b that is closer to the second end 12b. As discussed in greater detail below, annular groove 12d is configured to receive one or more latch mechanisms of locking cylinder 10 so that latch mechanisms of locking cylinder 10 automatically lock inner tube 12 and an outer tube of locking cylinder 10 with one another when the extension boom 8 is in the stored position.

Still referring to inner tube 12, inner tube 12 also includes a ramp 12e that extends longitudinally from the second end 12b and terminates at the annular groove 12d. As best seen in FIG. 3A, ramp 12e includes a first portion 12e-1 that extends longitudinally from the second end 12b towards the annular groove 12d to a medial point located between the second end 12b and annular groove 12d. Ramp 12e also includes a second portion 12e-2 that extends longitudinally from the annular groove 12d to the first portion 12e-1. In the present disclosure, the first portion 12e-1 is oriented at a first angle relative to the longitudinal axis of inner tube 12, and the second portion 12e-2 is oriented at a second angle relative to the longitudinal axis of inner tube 12 that is different than the first angle of the first portion 12e-1. When viewed from a sectional view, as shown in FIG. 3A, the first portion 12e-1 extends outwardly from the second end 12b to the intersection of the first and second portions 12e-1, 12e-2, and the first portion 12e-1 extends inwardly from the intersection of the first and second portions 12e-1, 12e-2 to the annular groove 12d.

Locking cylinder 10 also includes a second or outer tube 14 that slidably engages with the inner tube 12 such that the outer tube 14 houses a portion of inner tube 12 (see FIGS. 2 and 3). In the present disclosure, outer tube 14 includes a first end 14a, a second end 14b that is opposite to the first end 14a, and a longitudinal axis defined between the first end 14a and the second end 14b. As best seen in FIG. 3, outer tube 14 also defines an outer passageway 14c that extends along the longitudinal axis of outer tube 14 between first end 14a and second end 14b; it should be noted that first end 14a and second end 14b are open ends and may access outer passageway 14c at either the first end 14a or second end 14b. Outer tube 14 also defines an engagement wall 14d that is positioned inside of outer passageway 14c at the second end 14b; such use and purpose of engagement wall 14d is discussed in greater detail below. In one exemplary embodiment, engagement wall 14d may define a threading that is positioned inside of outer passageway 14c at the second end 14b.

Locking cylinder 10 also includes a base 16 that operably engages with outer tube 14 and is configured to receive a portion of the inner tube 12 when the extension boom 8 is in the stored position and the locking cylinder 10 is in the retracted position. As best seen in FIG. 3, base 16 includes a first end 16a that operably engages with the outer tube 14, a second end 16b opposite to the first end 16a, and a longitudinal axis defined between the first end 16a and the second end 16b. Base 16 also includes an exterior surface 16c that extends between the first end 16a and the second end 16b and is in communication with the exterior environment surrounding the base 16. Base 16 also includes an interior surface 16d that extends between the first end 16a and the second end 16b and assists in defining an interior space or chamber 16e defined by the base 16. Chamber 16e of base 16 is also accessible from an opening 16f defined at first end 16a of base 16 that is configured to receive a portion of inner tube 12 as outer tube 14 and base 16 collectively move between the retracted and extended positions, which are discussed in greater detail below. Base 16 also defines an engagement wall 16g at the first end 16a to engage the base 16 with the engagement wall 14d of outer tube 14 where the outer tube 14 and base 16 are fixedly engaged with one another. In one exemplary embodiment, the engagement walls 14d,16g of outer tube 14 and base 16 may be maintained with one another via a weld or similar attachment so that the outer tube 14 and base 16 remain with one another while still capable of being removed from one another; as such, base 16 is removably engaged with the outer tube 14 for ease of repairing base 16 in isolation or to replace a used or damaged base 16 with a new or refurbished base 16. In another exemplary embodiment, the engagement walls 14d,16g of outer tube 14 and base 16 may define matching threads so that the outer tube 14 and base 16 are engaged with one another; as such, base 16 is releasably engaged with the outer tube 14 for ease of repairing base 16 in isolation or to replace a used or damaged base 16 with a new or refurbished base 16.

In this embodiment, a weld bead or weld seam 17 fixedly engages the outer tube 14 and base 16 with one another to provide a fluid tight or airtight barrier at the engagement point between the outer tube 14 and base 16. In other exemplary embodiments, other suitable components may be used to provide a fluid tight or airtight barrier at the engagement point between the outer tube 14 and base 16. In one exemplary embodiment, a seal (such as a gasket or O-ring) may be positioned between the outer tube 14 and base 16 to provide a fluid tight or airtight barrier at the threaded connection between the outer tube 14 and base 16.

Still referring base 16, base 16 also defines a pair of locking passageways 16h. As best seen in FIG. 3, each locking passageway of the pair of locking passageways 16h extends between the exterior surface 16c and the interior surface 16d along an axis that is non-parallel to or orthogonal to the longitudinal axis of base 16; as such, the exterior surface 16c and the interior surface 16d are in communication with one another at each locking passageway of the pair of locking passageways 16h. It should be noted that each locking passageway of the pair of locking passageways 16h also provides access to the chamber 16e in which the chamber 16e and the exterior environment surrounding the base 16 are in communication with one another at each locking passageway of the pair of locking passageways 16h.

It should be understood that each locking passageway of the pair of locking passageways 16h of base 16 is identical to one another such that locking passageways 16h are mirror images of one another relative to the longitudinal axis of base 16. For brevity, a first locking passageway of the pair of locking passageways 16h (highlighted in FIG. 3A) will be described in further detail. It should be noted, however, that such elements and features that define the first locking passageway shown in FIG. 3A apply equally to a second locking passageway of the pair of locking passageways 16h.

In FIG. 3A, locking passageway 16h is defined by a first lateral surface 16i of base 16 that extends from the exterior surface 16c to a first shoulder 16j and defines a first diameter. Base 16 also defines an internal notch 16k inside of the locking passageway 16h that is located along the first lateral surface 16i at a position between the exterior surface 16c and the first shoulder 16j. Locking passageway 16h is also defined by a second lateral surface 16m that extends from the first shoulder 16j to a second shoulder 16n and defines a second diameter that is less the first diameter of the first lateral surface 16i. Locking passageway 16h is also defined by a third lateral surface 16p that extends from the second shoulder 16n to the interior surface 16d of base 16 and defines a third diameter that is less the first and second diameters of the first lateral surface 16i and second lateral surface 16m. As discussed in greater detail below, base 16 is configured to receive and engage with a latch mechanism inside of each locking passageway of the pair of locking passageways 16h to automatically lock the outer tube 14 and base 16 with the inner tube 12 when a mechanical load is absent or to automatically unlock the outer tube 14 and base 16 from the inner tube 12 when a mechanical load is presented and applied to each latch mechanism.

Locking cylinder 10 also includes a mechanical load system or unit 18 that operably engages with the inner tube 12 (see FIG. 2). In the present disclosure, mechanical load unit 18 is in fluid communication with the inner passageway 12c of inner tube 12. Such communication between the inner tube 12 and mechanical load unit 18 allows the mechanical load unit 18 to deliver a mechanical load into the locking cylinder 10 and to withdraw said mechanical load from the locking cylinder 10 so that outer tube 14 and base 16, collectively, may move between a retracted position and an extended position relative to the inner tube 12 to retract or extend the extension boom 8.

It should be noted that any suitable load system or unit may be used for locking cylinder 10 and other locking cylinders discussed herein for moving outer tube 14 and base 16, collectively, a retracted position and an extended position relative to the inner tube 12 to retract or extend the extension boom 8. In one exemplary embodiment, a load unit may be a hydraulic system or unit that may be introduce hydraulic fluid into locking cylinder 10 and to withdraw hydraulic fluid from locking cylinder 10 so that outer tube 14 and base 16, collectively, may move between a retracted position and an extended position relative to the inner tube 12 to retract or extend the extension boom 8. In another exemplary embodiment, a load unit may be an pneumatic system or unit that may be introduce and withdraw compressed air or gas into a locking cylinder 10 so that outer tube 14 and base 16, collectively, may move between a retracted position and an extended position relative to the inner tube 12 to retract or extend the extension boom 8. In another exemplary embodiment, a load unit may be an electric system or unit that may be apply torque into a locking cylinder 10 so that outer tube 14 and base 16, collectively, may move between a retracted position and an extended position relative to the inner tube 12 to retract or extend the extension boom 8.

Locking cylinder 10 also includes at least one latch mechanism 20 that operably engages with the base 16 and is configured to automatically lock or unlock the outer tube 14 with the inner tube 12. In the present disclosure, locking cylinder 10 includes a pair of latch mechanisms 20 that operably engages with the base 16 inside of the pair of locking passageways 16h and is configured to automatically lock or unlock the outer tube 14 with the inner tube 12. It should be understood that each latch mechanism of the pair of latch mechanisms 20 is identical to one another such that latch mechanisms 20 are mirror images of one another relative to the longitudinal axis of base 16. For brevity, a first latch mechanism of the pair of latch mechanisms 20 (highlighted in FIG. 3A) will be described in further detail. It should be noted, however, that such elements and features that make up the first latch mechanism shown in FIG. 3A apply equally to a second latch mechanism of the pair of latch mechanisms 20.

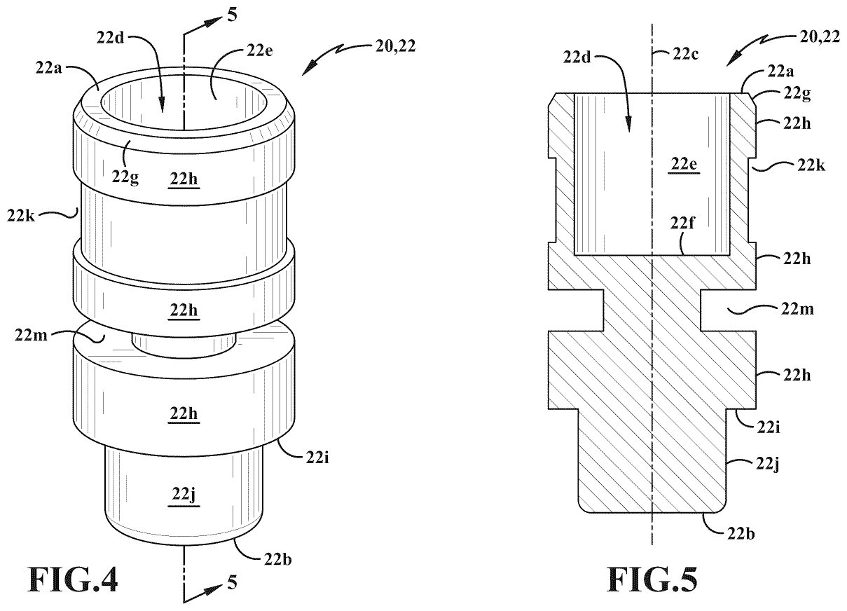

In FIGS. 4 and 5, latch mechanism 20 includes a piston 22 that is configured to automatically lock or unlock the outer tube 14 with the inner tube 12. As best seen in FIGS. 4 and 5, piston 22 includes a first or non-locking end 22a, a second or locking end 22b opposite to the non-locking end 22a and is configured to engage with the inner tube 12 inside of the annular groove 12d, and a longitudinal axis 22c extending between the non-locking end 22a and the locking end 22b. Piston 22 also defines a cavity 22d that extends along an internal lateral surface 22e from the non-locking end 22a to an internal base surface 22f; such use and purpose of cavity 22d is discussed in greater detail below.

Still referring FIGS. 4-5, piston 22 also includes a chamfer 22g that extends from the non-locking end 22a to a first lateral exterior surface 22h. The first lateral exterior surface 22h extends from the chamfer 22g to a shoulder or stop 22i. In operation, and as discussed in greater detail below, the stop 22i is configured to engage with the second shoulder 16n of base 16 to cease linear movement of the piston 22 as the piston 22 moves between a locked position and an unlocked position. Piston also includes a second lateral exterior surface 22j that extends from the stop 22i to the locking end 22b. Piston 22 also defines an annular cutout 22k in the first lateral exterior surface 22h at a location between the non-locking end 22a and the stop 22i. Piston 22 also defines an annular slot 22m in the first lateral exterior surface 22h at a location between the stop 22i and the annular cutout 22k; such use and purpose of the annular slot 22m is discussed in greater detail below.

Latch mechanism 20 also includes a latch plate 24 that operably engages with the base 16. Particularly, and as best seen in FIG. 3A, latch plate 24 operably engages with a portion of the first lateral surface 16i and the first shoulder 16j defined inside a respective locking passageway of the pair of locking passageways 16h. Latch plate 24 includes a first or outer end 24a that faces in a first direction towards the exterior surface 16c of base 16, a second or inner end 24b facing in a second direction opposite to the first direction and towards the chamber 16e of base 16, and a through-hole 24c extending entirely through the latch plate 24 between the outer end 24a and the inner end 24b; the outer end 24a and the inner end 24b are in communication with one another at the through-hole 24c. In operation, latch plate 24 is configured to allow air trapped inside of the locking passageway 16h to escape through the through-hole 24c of latch plate 24 as the piston 22 moves from the locked position to the unlocked position. As discussed in greater detail below, latch plate 24 is also configured to act as a support structure to support a biaser of the latch mechanism 20 so that the biaser may apply a biasing force against the piston 22.

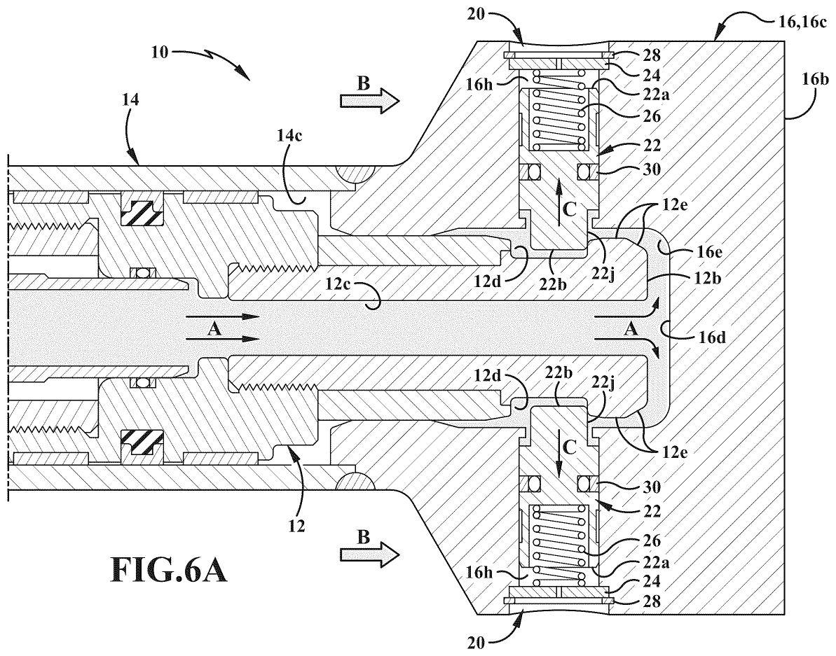

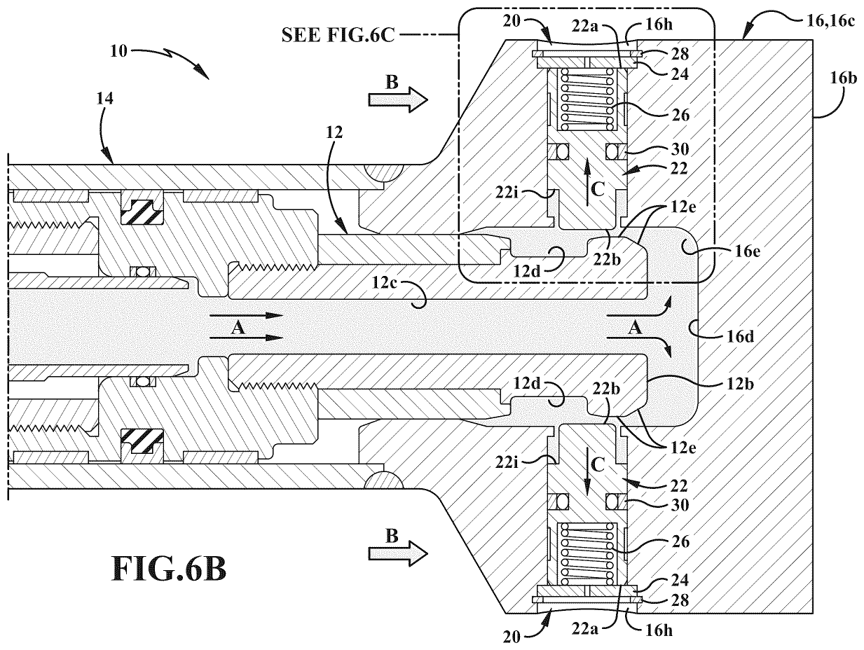

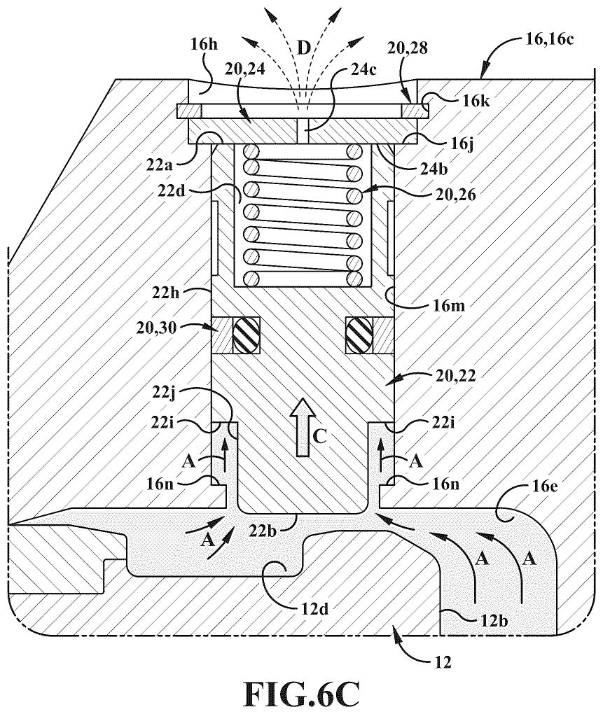

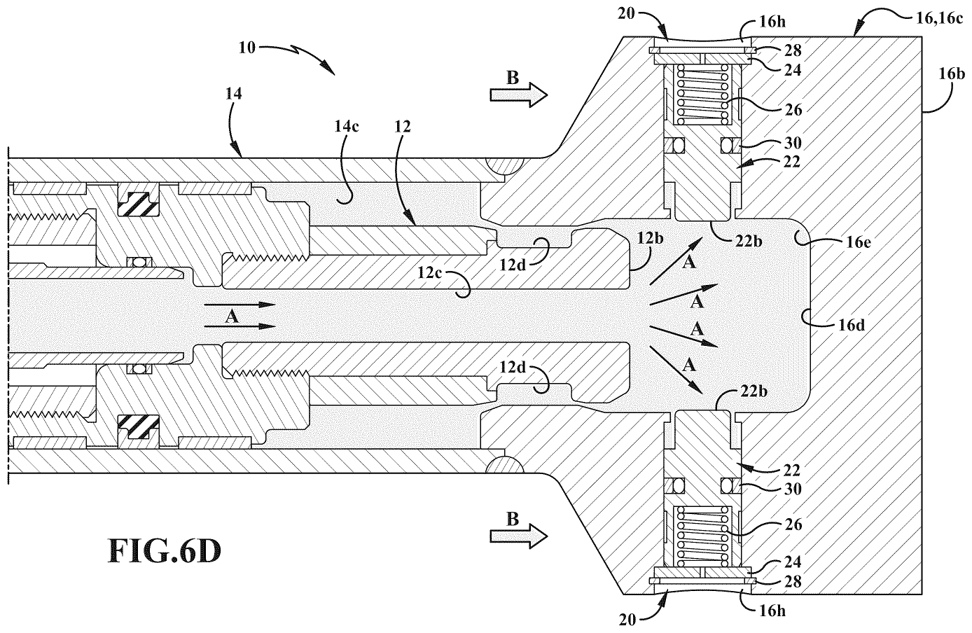

Latch mechanism 20 also includes a biaser 26 that operably engages with piston 22 and latch plate 24. As best seen in FIG. 3A, biaser 26 includes a first end 26a that operably engages with piston 22, particularly the base surface 22f inside of cavity 22d, a second end 26b that operably engages with the latch plate 24, particularly the inner end 24b, and a biasing axis extending between the first end 26a and the second end 26b. In operation, biaser 26 is configured to apply a biasing force against the piston 22 and the latch plate 24 in opposing directions along the biasing axis so that piston 22 is biased to the locked position (see FIG. 3A). In operation, the biasing force applied by the biaser 26 may be overcome when a load or pressure exerted inside of the locking cylinder 10 is greater than the biasing force applied by the biaser to move the piston 22 to an unlocked position (see FIGS. 6C-6D).

In the present disclosure, biaser 26 is a compression-type spring that is configured to apply a biasing force against the piston 22 and the latch plate 24 in opposing directions so that piston 22 is biased to the locked position. In other exemplary embodiments, any suitable type of biaser or spring may be used to apply a biasing force against the piston 22 so that piston 22 is biased to the locked position. Examples of suitable springs that may be included in latch mechanism 20 (or other latch mechanisms disclosed herein) to bias piston 22 to a locked position include expansion springs, torsion springs, spiral springs, disk springs, square or rectangular springs, linear springs, variable-rate springs, flat springs, serpentine springs, pneumatic springs, hydraulic springs, gas springs, and other types of springs that may be used for this latch mechanism 20 (or other latch mechanisms disclosed herein) to bias piston 22 to a locked position.

Latch mechanism 20 also includes a retainer 28. As best seen in FIG. 3A, retainer 28 operably engages with the base 16 inside of the respective locking passageway 16h at internal notch 16k. Once engaged, retainer 28 retains the piston 22, the latch plate 24, and the biaser 26 inside of the respective locking passageway 16h as the biaser 26 presses outwardly against the piston 22 and the latch plate 24. In the present disclosure, retainer 28 is a snap ring or retaining ring that retains the piston 22, the latch plate 24, and the biaser 26 inside of the respective locking passageway 16h as the biaser 26 presses outwardly against the piston 22 and the latch plate 24. In other exemplary embodiments, any suitable retainer or retainer clip that is commercially available may be used to engage with the base 16 and to retain the piston 22, the latch plate 24, and the biaser 26 inside of the respective locking passageway 16h. Examples of suitable retainer clips include spring clips, push-in or push-on retainer clips, E-clips, cotter pins, and other suitable retainer clips that may be used to engage with the base 16 and to retain the piston 22, the latch plate 24, and the biaser 26 inside of the respective locking passageway 16h.

Latch mechanism 20 also includes a seal ring 30 that operably engages with piston 22. As best seen in FIG. 3A, seal ring 30 operably engages with piston 22 inside of the annular slot 22m to provide a fluid tight seal or an airtight barrier between the piston 22 and the second lateral surface 16m of the base 16 inside of the respective locking passageway 16h. As discussed in greater detail below, hydraulic fluid that is exerted into the locking cylinder 10 and comes in contact with the piston 22 is prevented from escaping around the piston 22 and outside of the base 16 through the respective locking passageways of the pair of locking passageways 16h due to the inclusion of seal ring 30.

The structural configuration of each latch mechanism 20 is considered advantageous at least because each latch mechanism 20 automatically locks the outer tube 14 and base 16, collectively, with the inner tube 12 or automatically unlocks the outer tube 14 and base 16, collectively, from the inner tube 12 based on the presence of a mechanical load exerted on each latch mechanism 20. In the locked position, each latch mechanism 20 is configured to automatically lock the outer tube 14 and base 16, collectively, with the inner tube 12 when the piston 22 of each latch mechanism 20 is pressed into the annular groove 12d of inner tube 12 by respective biaser 26 in a first direction and a mechanical load is free from being exerted on each latch mechanism 20 in an opposing second direction. In the unlocked position, each latch mechanism 20 is configured to automatically unlock the outer tube 14 and base 16, collectively, from the inner tube 12 when the piston 22 of each latch mechanism 20 is moved away from the annular groove 12d of inner tube 12 by a mechanical load being exerted on each latch mechanism 20 that overcomes the biasing force applied by the respective biaser 26. With such automatic locking capability, operators and users of articulating boom 2 having locking cylinder 10 are free performing further steps or procedures to lock and/or secure the extension boom 8 when transporting the articulating boom 2 between job sites.

The structural configuration of the locking cylinder 10 is also considered advantageous at least because the base 16 is removably engaged with the outer tube 14 for ease of repairing a preexisting base 16 or installing a new base 16 to the preexisting outer tube 14 of the locking cylinder 10. Additionally, the procedures of repairing base 16 and/or installing a new base 16 may be performed with ease since the base 16 and the latch mechanisms 20 is free from plumbing any fluids or mechanical loads into the locking cylinder 10 that are used to actuate locking cylinder 10 between the retracted position and the extended position during use. Further, the base 16 (including the pair of latch mechanisms 20) may be repaired remotely from the locking cylinder 10 and/or the articulating boom 2 by simply unthreading or unscrewing the base 16 from the outer tube 14. Similarly, a new or refurbished base 16 may replace a used or damaged base 16 by simply threading or engaging the new base 16 with the outer tube 14 in the field or in an operator's facility or shop.

Having now described the components of locking cylinder 10, methods of using the locking cylinder 10 to move the upper boom 8b and platform 8c between the stored position and the operating position are discussed in greater detail below.

FIGS. 6A-7 illustrate a first method of operating locking cylinder 10 to move the upper boom 8b and platform 8c from the retracted position to the extended position. Initially, a mechanical load (such as hydraulic fluid) is introduced into the inner passageway 12c of inner tube 12 from the mechanical load unit 18; such introduction of the mechanical load into the inner tube 12 is denoted by arrows labeled “A” in FIGS. 6A-6D. The mechanical load is forced out of the inner passageway 12c of inner tube 12 and exits from the second end 12b of inner tube 12 into the chamber 16e of base 16. The mechanical load continues to fill the chamber 16e of base 16 and fills around the exterior surface of inner tube 12 along the second end 12b of inner tube 12 inside of the outer passageway 14c. With such introduction this mechanical load, the outer tube 14 and the base 16, collectively, begin to move from the retracted position towards the extended position and move away from the inner tube 12 (see FIG. 6A); such movement of the outer tube 14 and the base 16 from the retracted position towards the extended position is denoted by arrows labeled “B” in FIGS. 6A-6B and 6D.

As the mechanical load fills the chamber 16e of base 16, the mechanical load interacts with each latch mechanism of the pair of latch mechanisms 20 to move the pistons 22 from the locked position to the unlocked position; such movement of the pistons 22 from the locked position to the unlocked position is denoted by arrows labeled “C” in FIGS. 6A-6C. As best seen in FIG. 6A, the mechanical load presses against one or more of the locking end 22b, the second lateral exterior surface 22j, and the stop 22i of each piston 22 to move the piston 22 away from the inner tube 12 and into the respective locking passageway of the pair of locking passageways 16h of the base 16. At this stage, the mechanical load is exerting a force that is greater than the biasing force applied by each biaser 26 against a respective piston 22 to transition the respective piston 22 from the locked position to the unlocked position. As such, the biasers 26 are compressed from an expanded state (see FIG. 3A) toward compressed states so that pistons 22 move away from the inner tube 12 to unlocked positions. As the pistons 22 move away from the inner tube 12, the second lateral exterior surface 22j of each piston 22 may slide along an internal side surface or wall of inner tube 12 that defines the annular groove 12d of inner tube 12 as the outer tube 14 and base 16 are being forced away from the inner tube 12 by the pressure exerted by the mechanical load (see FIG. 6A).

The mechanical load exerted on each piston 22 of the pair of latch mechanism 20 may continue to transition each piston 22 away from the annular groove 12d of inner tube 12 to the unlocked position until the non-locking end 22a of each piston 22 abuts the latch plate 24 (see FIGS. 6B and 6C). As each piston 22 moves from the locked position to the unlocked position, air trapped inside of the respective locking passageway 16h of base 16 may be exerted through the through-hole 24c of latch plate 24 and through the retainer 28; such exertion of air from the base 16 is denoted by arrows labeled “D” in FIG. 6C. Such escapement of air may be desired to prevent unwanted pressure inside of each locking passageway 16h and each piston 22 that works against the mechanical load that automatically moves each piston 22 to the unlocked position. It should be noted that the piston 22 is also considered to be in the unlocked position once the locking end 22b of a respective piston 22 is positioned outside of the annular groove 12d of inner tube 12 and is free from engaging with the inner tube 12.

Once each piston 22 of the respective latch mechanism 20 is in the unlocked position, the second end 14b of outer tube 14 and the base 16, collectively, may continue to move away from the second end 12b of inner tube 12 towards a desired extended position (see FIG. 6D). As such, the outer tube 14 and the base 16 may move towards a desired extended position based on the operator's input. In one example, the operator of articulating boom 2 may extend the platform 8c of extension boom 8 to a desired aerial position thus causing mechanical load to be introduced into the inner tube 12 and exerted against the outer tube 14 and the base 16 to extend the locking cylinder 10. Such movement of the extension boom 8 from the stored position to a desired operating position by the locking cylinder 10 is illustrated in FIG. 7. It should be noted that while locking cylinder 10 may retract or extend periodically depending on the operator's input, the pair of latch mechanisms 20 remains in the unlocked position until the mechanical load is removed and the extension boom 8 is moved to the stored position.

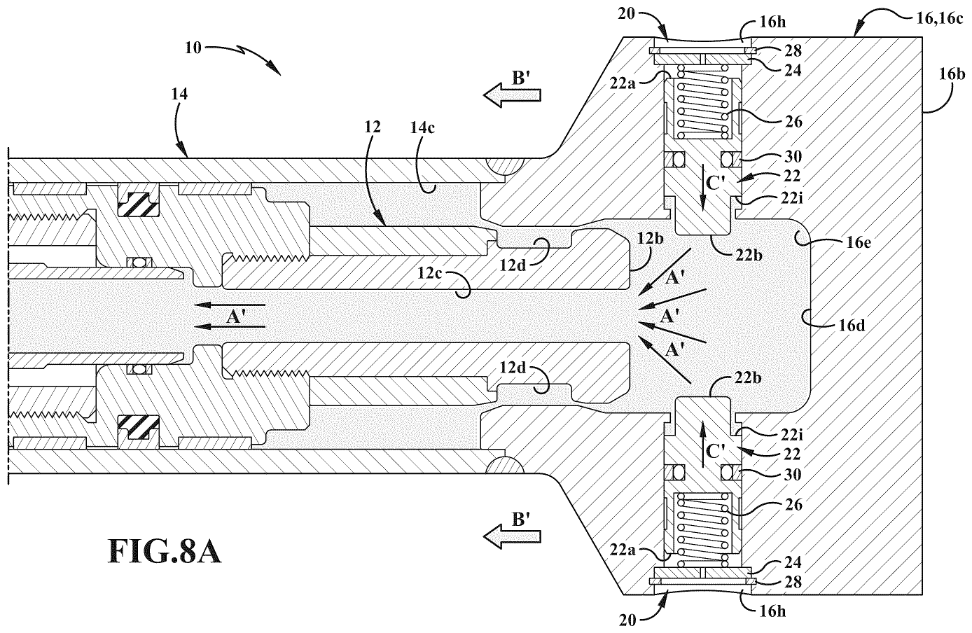

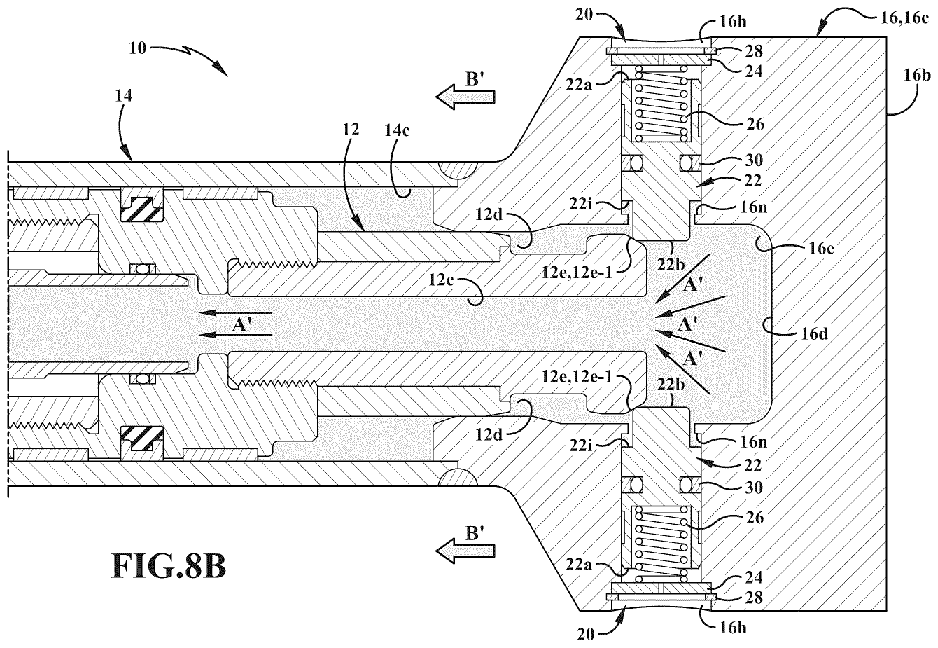

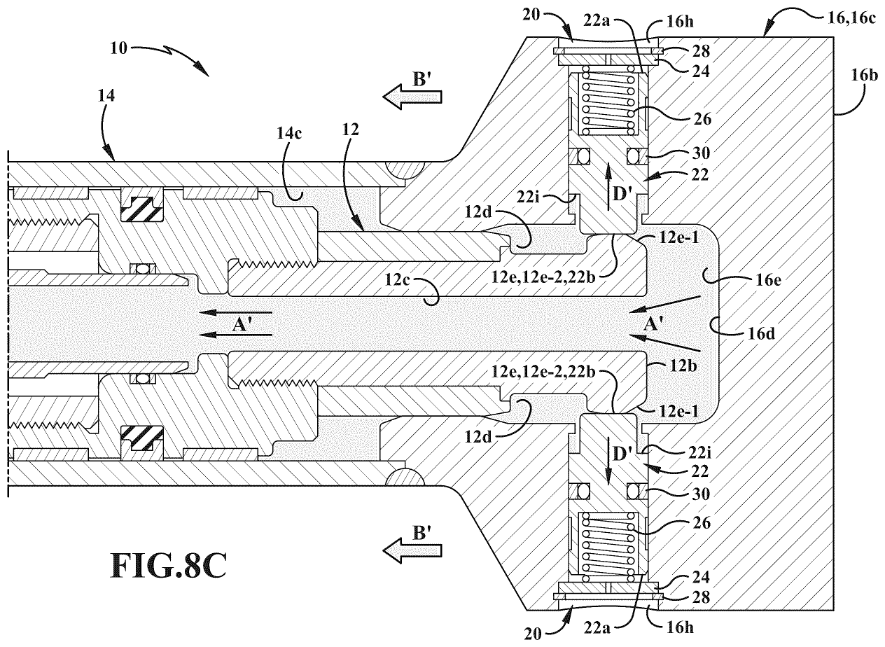

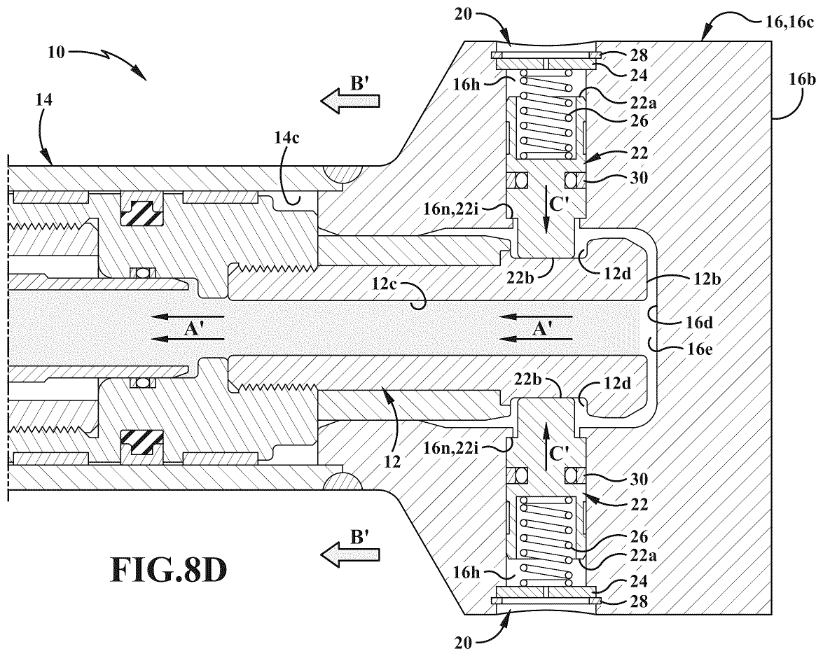

FIGS. 8A-9 illustrate a second method of operating locking cylinder 10 to move the upper boom 8b and platform 8c from the extended position to the stored position. Initially, a mechanical load (such as hydraulic fluid) that is exerted against the inner tube 12, the outer tube 14, and base 16 is withdrawn through the inner passageway 12c of inner tube 12 by the mechanical load unit 18; such withdrawal or removal of the mechanical load into the inner tube 12 is denoted by arrows labeled “A′” in FIGS. 8A-8D. At this stage, the mechanical load is withdraw from the outer passageway 14c of outer tube 14 and the chamber 16e of base 16 and into the inner passageway 12c at the second end 12b of inner tube 12. As the mechanical load is being withdrawn, the outer tube 14 and the base 16, collectively, begin to move from the extended position towards the retracted position and move towards the inner tube 12 (see FIGS. 8A-8D); such movement of the outer tube 14 and the base 16 from the extended position towards the retracted position is denoted by arrows labeled “B′” in FIGS. 8A-8D.

As the mechanical load is withdrawn from the chamber 16e of base 16, the mechanical load is removed from each latch mechanism of the pair of latch mechanisms 20 which automatically moves the pistons 22 from the unlocked position back to the locked position based on the biasing force from the respective biaser 26; such movement of the pistons 22 from the unlocked position back to the locked position by the respective biaser 26 is denoted by arrows labeled “C′” in FIGS. 6A-6C. As best seen in FIG. 6A, the mechanical load is removed from one or more of the locking end 22b, the second lateral exterior surface 22j, and the stop 22i of each piston 22 to move the piston 22 towards the inner tube 12 and into the chamber 16e of the base 16. As the mechanical force is being withdrawn from the pair of latch mechanisms 20, the biasing force applied by each biaser 26 against a respective piston 22 is no longer overcome and biases the respective piston 22 from the unlocked position to the locked position. As such, the biasers 26 expand from compressed states (see FIGS. 6C-6D) back to the expanded states (FIG. 3A) so that pistons 22 automatically move towards the inner tube 12 to locked positions.

As the base 16 moves back towards the second end 12b of inner tube 12 (with the outer tube 14), the locking end 22b of each piston 22 may ride or slide along ramp 12e of inner tube 12 as the pair of latch mechanisms 20 progress towards the locked position. As best seen in FIG. 8B, the locking end 22b of each piston 22 initially contacts and rides along the first portion 12e-1 of ramp 12e as the outer tube 14 and base 16 move back towards the inner tube 12. As the locking end 22b of each piston 22 rides along the first portion 12e-1 of ramp 12e and transitions to the second portion 12e-2 of ramp 12e, the interaction between each piston 22 and the first portion 12e-1 of ramp 12e causes each piston 22 to move back into the respective locking passageway 16h of base 16; such force exerted against each piston 22 by ramp 12e is denoted by an arrow labeled “D′” in FIG. 8C. As such, the force exerted against each piston 22 by the ramp 12e is greater than the biasing force applied by the respective biaser 26 causing the pistons 22 to move back into the locking passageways 16h until seated back in the annular groove 12d.

Each piston 22 of the pair of latch mechanism 20 may continue to ride along the ramp 12e until the locking end 22b of each piston 22 automatically falls into the annular groove 12d of inner tube 12 as the outer tube 14 and the base 16 progress towards the inner tube 12 and the retracted position. As best seen in FIG. 8D, the locking end 22b of each piston 22 previously rode along the entire ramp 12e of inner tube 12 and is seated into the annular groove 12d of inner tube 12 such that each piston 22 is now provided in the locked position. As the locking end 22b of each piston 22 reaches the end of the ramp 12e, the respective biaser 26 continues to apply an outward force on the piston 22 so that the piston 22 automatically locks the outer tube 14 and base 16 with inner tube 12 at the annular groove 12d (see FIG. 8D). It should be noted that the piston 22 is also considered to be in the locked position once the locking end 22b of a respective piston 22 is positioned inside of the annular groove 12d of inner tube 12 and engages with at least one internal surface or wall that defines the annular groove 12d of inner tube 12.

Once each piston 22 of the respective latch mechanism 20 is in the locked position, the outer tube 14 and the base 16, collectively, are automatically locked with the inner tube 12 by the latch mechanisms 20 (see FIG. 8D). At this stage, the platform 8c of extension boom 8 is moved towards the lower boom 8a, and the upper boom 8b is positioned substantially inside of the lower boom 8a once the mechanical load is withdrawn and is free from being applied to the pair of latch mechanisms 20. Such movement of the extension boom 8 from the operating position to the stored position by the locking cylinder 10 is illustrated in FIG. 9. It should be noted that once the outer tube 14 and the base 16 are automatically locked with the inner tube 12 by the latch mechanisms 20, the operator may then lower extension boom 8 and other components of articulating boom 2 to a safe or stored position prior to transporting articulating boom 2 with lift vehicle 1.

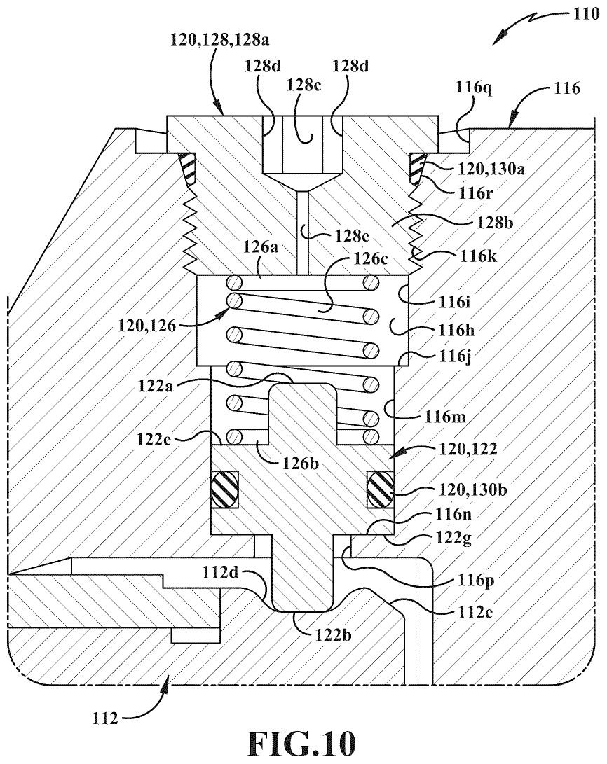

FIGS. 10-12 illustrate another locking cylinder 110 having at least one latch mechanism 120 that is similar to the locking cylinder 10 having the at least one latch mechanism 20 discussed above and illustrated in FIGS. 1-9. Such locking cylinder 110 may be used with articulating boom 2 discussed above and other types of lifting booms mentioned herein. In FIG. 10, locking cylinder 110 includes an inner tube 112 and an outer tube (not illustrated) that are substantially similar to inner tube 12 and outer tube 14 of locking cylinder 10. It should be noted, however, that any differences between the locking cylinders 10, 110, including differences between latch mechanisms 20, 120, will be described in greater detail below.

In FIG. 10, locking cylinder 110 includes a base 116 that is similar to base 16 discussed above. However, in this present disclosure, base 116 includes additional components that assist in forming and/or defining each locking passageway of a pair of locking passageways 116h. As best seen in FIG. 10, each locking passageway 116h is defined by a first lateral surface 116i of base 116 that extends from an exterior surface 116c to a first shoulder 116j and defines a first diameter. In this embodiment, base 116 also defines an internal threading 116k inside of each locking passageway 116h that is located along the first lateral surface 116i at position between the exterior surface 116c and the first shoulder 116j; such use and purpose of internal threading 116k is discussed in greater detail below. Each locking passageway 116h is also defined by a second lateral surface 116m that extends from the first shoulder 116j to the second shoulder 116n and defines a second diameter that is less the first diameter of the first lateral surface 116i. Each locking passageway 116h is also defined by a third lateral surface 116p that extends from the second shoulder 116n to an interior surface 116d of base 116 and defines a third diameter that is less the first and second diameters of the first lateral surface 116i and second lateral surface 116m. As discussed in greater detail below, base 116 is configured to receive and engage with a latch mechanism inside of each locking passageway of the pair of locking passageways 116h to automatically lock and unlock the outer tube with the inner tube 112.

Still referring to FIG. 10, each locking passageway 116h is also defined by a counterbore 116q that extends from the exterior surface 116c to a chamfer 116r. In this present embodiment, the chamfer 116f extends from the counterbore 116q to the first lateral surface 116i. Such use and purpose of the counterbore 116q and the chamfer 116f to define each locking passageway of the pair of locking passageways 116h are discussed in greater detail below.

Locking cylinder 110 also includes at least one latch mechanism 120 that operably engages with the base 116 and is configured to automatically lock the outer tube and base 116 with the inner tube 112 or to unlock the outer tube and base 116 from inner tube 112. In the present disclosure, locking cylinder 110 may include a pair of latch mechanisms 120 that operably engages with the base 116 inside of the pair of locking passageways 116h and is configured to automatically lock the outer tube and base 116 with the inner tube 112 or to unlock the outer tube and base 116 from inner tube 112. It should be understood that each latch mechanism of the pair of latch mechanisms 120 is identical to one another such that latch mechanisms 120 are mirror images of one another relative to the longitudinal axis of base 116. For brevity, a first latch mechanism of the pair of latch mechanisms 120 (highlighted in FIG. 10) will be described in further detail. It should be noted, however, that such elements and features that make up the first latch mechanism shown in FIG. 10 apply equally to a second latch mechanism of the pair of latch mechanisms 120.

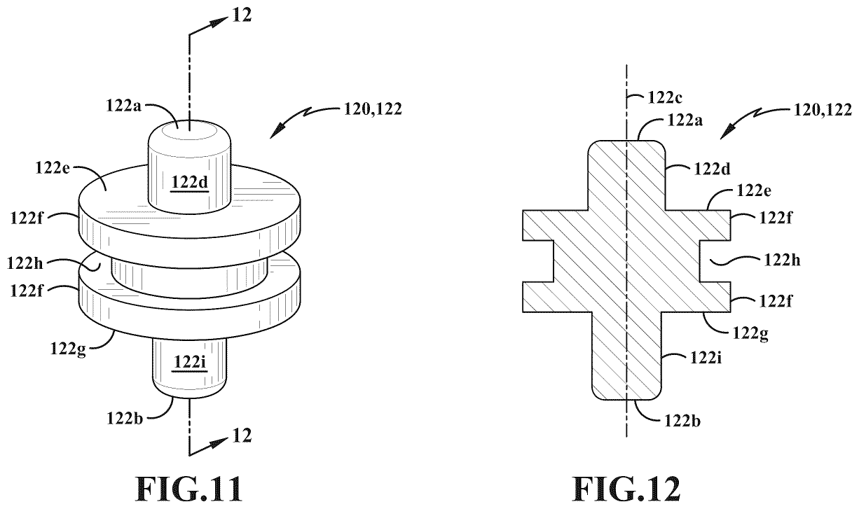

In FIGS. 11-12, latch mechanism 120 includes a piston 122 that is configured to automatically lock the outer tube and base 116 with the inner tube 112 or to unlock the outer tube and base 116 from inner tube 112. As best seen in FIGS. 11-12, piston 122 includes a first or non-locking end 122a, a second or locking end 122b opposite to the non-locking end 122a and configured to engage with the inner tube 112 inside of an annular groove 112d of inner tube 112, and a longitudinal axis 122c extending between the non-locking end 122a and the locking end 122b. In this embodiment, the locking end 122b defines a substantially planar and/or flat shape when viewed from a longitudinal sectional view (see FIGS. 10 and 12). It should be noted that such substantially planar and/or flat shape of the locking end 122b of piston 122 matches with an annular groove 112d defined in inner tube 112 to enable engagement between the inner tube 112 and piston 122 for locking operations. It should also be noted that piston 122 may ride along a ramp 112e that extends longitudinally from a second end of the inner tube 112 and terminates at the annular groove 112d similar to ramp 12e of inner tube 12 discussed above.

Still referring FIGS. 11-12, piston 122 also includes a first cylindrical surface 122d that extends from the non-locking end 122a to a first shoulder 122e and defines a first diameter. Piston 122 also includes a second cylindrical surface 122f that extends from the first shoulder 122e to a second shoulder 122g and defines a second diameter that is greater than the first diameter defined by first cylindrical surface 122d. In the present embodiment, second shoulder 122g may act as a stop to engage with the second shoulder 116n inside of a respective locking passageway 116h to prevent the piston 122 from exiting entirely from the respective locking passageway 116h when moving to the locked position. Piston 122 also defines an annular channel 122h in the second cylindrical surface 122f that is configured to receive and house a portion of a piston seal of latch mechanism 120, which is discussed in greater detail below. Piston 122 also includes a third cylindrical surface 122i that extends from the second shoulder 122g to the locking end 122b and defines a third diameter that is less than the second diameter of second cylindrical surface 122f.

Latch mechanism 120 also includes a biaser 126 that operably engages with piston 122 and a retainer (discussed below) of latch mechanism 120. As best seen in FIG. 10, biaser 126 includes a first end 126a that operably engages with piston 122, particularly the first shoulder 122e, a second end 126b that operably engages with the retainer, and a biasing axis extending between the first end 126a and the second end 126b. In operation, biaser 26 is configured to apply a biasing force against the piston 122 and the retainer in opposing directions so that piston 122 is biased to the locked position (see FIG. 10). In operation, the biasing force applied by the biaser 126 may be overcome when a mechanical load or pressure exerted inside of the locking cylinder 110 is greater than the biasing force applied by the biaser to automatically move the piston 122 to an unlocked position as discussed above with respect to piston 22 of latch mechanism 20.

Latch mechanism 120 also includes a retainer 128. As best seen in FIG. 10, retainer 128 operably engages with the base 116 inside of the respective locking passageway 116h, particularly with threading 116k located inside of the respective locking passageway 116h. Retainer 128 includes a head 128a that operably engages with the base 116 inside of the counterbore 116q defining the respective locking passageway 116h, a threaded shaft 128b extending from the head 128a and configured to threadably engage with the threading 116k located inside of the respective locking passageway 116h, and a lengthwise axis extending entirely through retainer 128 between the head 128a and the threaded shaft 128b. Retainer 128 also defines a cavity 128c formed by a plurality of facets 128d inside of the head 128a and partially inside of the threaded shaft 128b. During assembly and disassembly procedures, the cavity 128c and plurality of facets 128d allow an operator or technician to insert and engage an external tool that matches the structural configuration of the plurality of facets 128d to loosen or tighten the retainer 128 with the threading 116k located inside of the respective locking passageway 116h. Retainer 128 also defines a passage 128e that extends from the cavity 128c through the entire threaded shaft 128b along the lengthwise axis of the retainer 128. Similar to the through-hole 24c of latch plate 24, retainer 128 is configured to allow air trapped inside of the locking passageway 116h to escape through the passage 128e of retainer 128 as the piston 122 moves from the locked position to the unlocked position.

Once retainer 128 is engaged, retainer 128 retains the piston 122 and the biaser 126 inside of the respective locking passageway 116h as the biaser 126 presses outwardly against the piston 122 and the retainer 128 (see FIG. 10). In the present disclosure, retainer 128 is shown as a threaded plug or threaded stopper that retains the piston 122 and biaser 126 inside of a respective locking passageway 116h. In this embodiment, as shown in FIG. 10, each latch mechanism 120 omits the use of a latch plate (such as latch plate 24) and combines the functionality of the latch plate discussed herein into the retainer 128 alone.

Each latch mechanism 120 also includes a set of seal rings 130a, 130b. As best seen in FIG. 10, a first seal ring 130a operably engages with the retainer 128, particularly with the threaded shaft 128b. The first seal ring 130a provides a fluid tight seal or airtight barrier between the base 116 and the retainer 128 inside of a respective locking passageway 116h of the base 116 to prevent unwanted debris, fluid, or other external material into the base 116 of locking cylinder 110 at each locking passageway 116h. Still referring to FIG. 10, a second seal ring 130b operably engages with the piston 122 inside of the annular channel 122h defined in the second cylindrical surface 122f. The second seal ring 130b also provides a fluid tight seal or airtight barrier between the piston 122 and a respective second lateral surface 116m of base 116 that assists in defining the respective locking passageway 116h of the base 116 to prevent a mechanical load or fluid from escaping around the piston 122 and exiting from the base 116 as the piston 122 moves between the locked and unlocked positions.

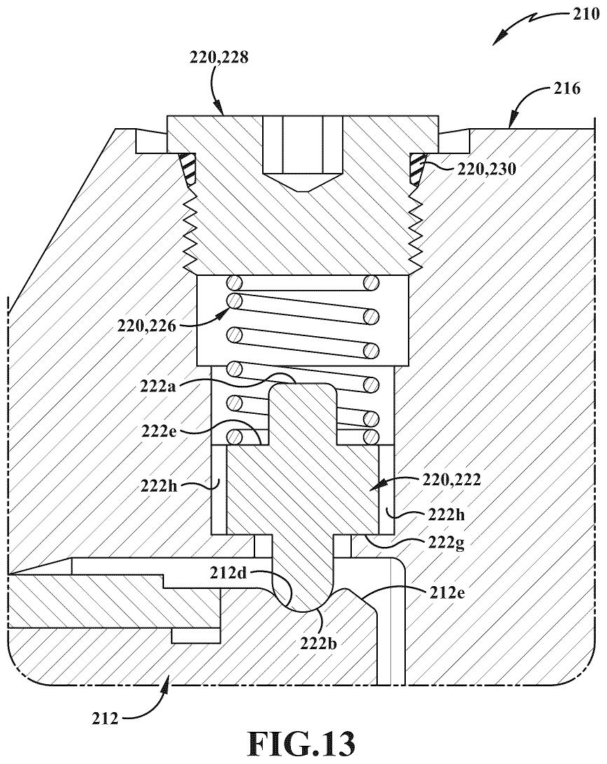

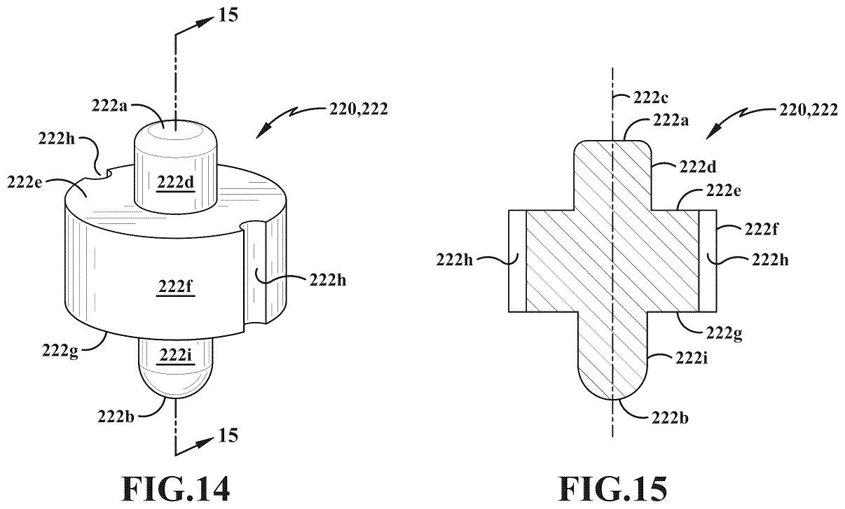

FIGS. 13-15 illustrate another locking cylinder 210 having at least one latch mechanism 220 that is similar to the locking cylinder 110 having the at least one latch mechanism 120 discussed above and illustrated in FIGS. 10-12. Such locking cylinder 210 may be used with articulating boom 2 discussed above and other types of lifting booms mentioned herein.

In FIG. 13, locking cylinder 210 includes an inner tube 212 and an outer tube (not illustrated) that are substantially similar to inner tubes 12, 112 and outer tube 14 of locking cylinders 10, 110 discussed previously. Locking cylinder 210 also includes a base 216 that is substantially similar to bases 16, 116 of locking cylinders 10, 110 discussed previously. Locking cylinder 210 also includes at least one latch mechanism 220 that operably engages with the base 216 to automatically lock the outer tube and base 216 with inner tube 212 or to automatically unlock the outer tube and base 216 from inner tube 212 substantially similar to the automatic locking or unlocking procedures of latch mechanisms 20, 120 discussed previously in locking cylinders 10, 110. While a single latch mechanism 220 is illustrated for brevity, locking cylinder 210 may include a pair of latch mechanisms 220 similar to the pair of latch mechanisms 20 used in locking cylinder 10. Latch mechanism 220 also includes a piston 222, a biaser 226, a retainer 228, and a pair of seal rings 230a, 230b that are similar to piston 122, biaser 126, retainer 128, and pair of seal rings 130a, 130b of latch mechanism 120 of locking cylinder 110.

With respect to piston 222, piston 222 is similar to piston 122 of each latch mechanism 120 previously discussed. Particularly, piston 222 includes a non-locking end 222a, a locking end 222b, a longitudinal axis 222c, a first cylindrical surface 222d, a first shoulder 222e, a second cylindrical surface 222f, a second shoulder 222g, and a third cylindrical surface 222i that are similar to non-locking end 122a, locking end 122b, longitudinal axis 122c, first cylindrical surface 122d, first shoulder 122e, second cylindrical surface 122f, second shoulder 122g, and third cylindrical surface 122i of piston 122.

However, in this embodiment, the locking end 222b defines a substantially rounded or oblong shape when viewed from a longitudinal sectional view (see FIGS. 13 and 15) as compared to the substantially planar and/or flat shape of the locking end 122b of piston 122 when viewed from a longitudinal sectional view (see FIGS. 10 and 12). It should be noted that such substantially rounded or oblong shape of the locking end 222b of piston 222 matches with an annular groove 212d defined in inner tube 212 to enable engagement between the inner tube 212 and piston 222 for locking operations. It should also be noted that piston 222 may ride along a ramp 212e that extends longitudinally from a second end of the inner tube 212 and terminates at the annular groove 212d similar to ramp 12e of inner tube 12 discussed above. Additionally, piston 222 defines at least one groove or channel 222h that is defined along the second cylindrical surface 222f of piston 222 and extends along an axis that is parallel to the longitudinal axis 222c of piston 222. In this embodiment, piston 222 defines a pair of channels 222h that is defined along the second cylindrical surface 222f of piston 222 and extends along an axis that is parallel to the longitudinal axis 222c of piston 222.

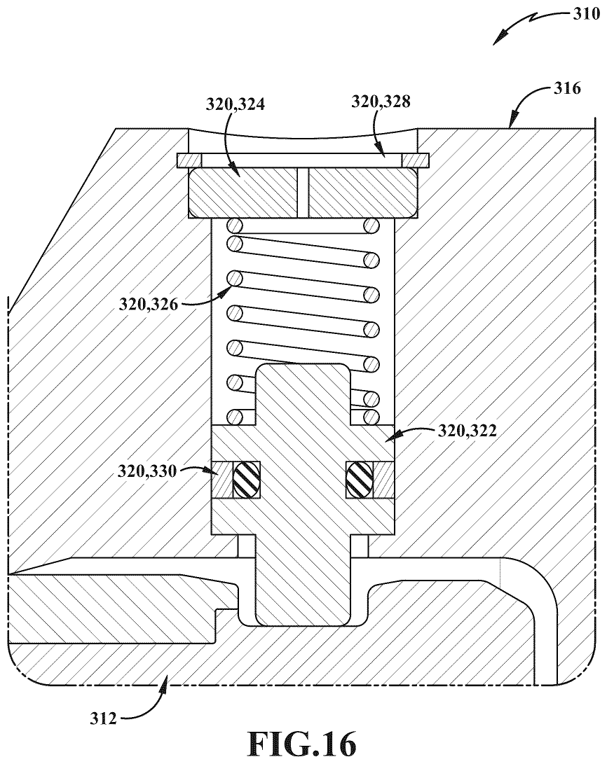

FIG. 16 illustrates another locking cylinder 310 having at least one latch mechanism 320 that is similar to the locking cylinders 10, 110 having the at least one latch mechanisms 20, 120 discussed above and illustrated in FIGS. 1-9 and in FIGS. 10-12. Such locking cylinder 310 may be used with articulating boom 2 discussed above and other types of lifting booms mentioned herein.

In FIG. 16, locking cylinder 310 includes an inner tube 312 and an outer tube (not illustrated) that are substantially similar to inner tube 12 and outer tube 14 of locking cylinder 10 discussed previously. Locking cylinder 310 also includes a base 316 that is substantially similar to base 16 of locking cylinder 10 discussed previously. Locking cylinder 310 also includes at least one latch mechanism 320 that operably engages with the base 316 to automatically lock the outer tube and base 316 with inner tube 312 or to automatically unlock the outer tube and base 316 from inner tube 312 substantially similar to the automatic locking or unlocking procedures of latch mechanisms 20, 120 discussed previously in locking cylinders 10, 110. While a single latch mechanism 320 is illustrated for brevity, locking cylinder 310 may include a pair of latch mechanisms 320 similar to the pair of latch mechanisms 20 used in locking cylinder 10.

In this embodiment, latch mechanism 320 also includes a piston 322 and a biaser 326 that are identical to piston 122 and biaser 126 of each latch mechanism 120 of locking cylinder 110. However, in this embodiment, latch mechanism 320 also includes a latch plate 324 that is identical to latch plate 24 of each latch mechanism 20 of locking cylinder 10, a retainer 328 that is identical to retainer 28 of each latch mechanism 20 of locking cylinder 10, and a seal 330 that is identical to seal ring 30 of each latch mechanism 20 of locking cylinder 10. As such, each latch mechanism 320 of locking cylinder 310 uses components of latch mechanisms 20, 120 of locking cylinders 10, 110 previous discussed herein and illustrated in FIGS. 1-9 and FIGS. 10-12.

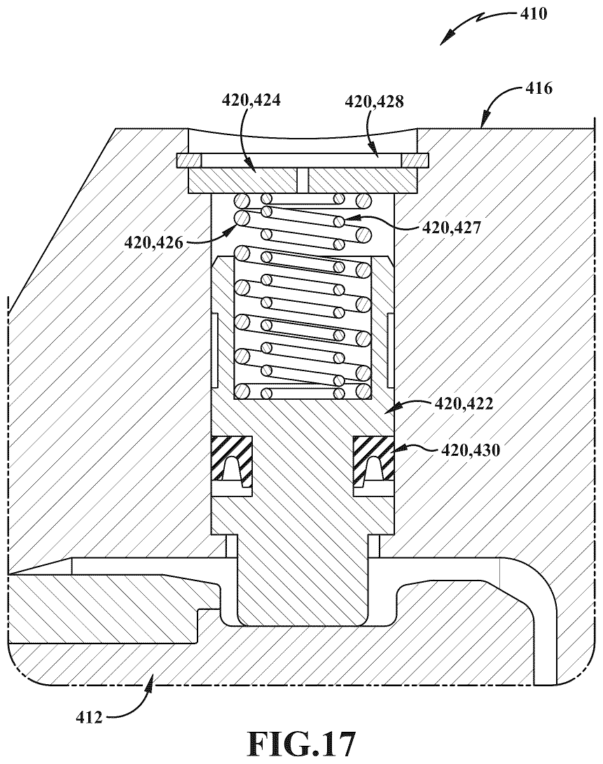

FIG. 17 illustrates another locking cylinder 410 having at least one latch mechanism 420 that is similar to the locking cylinder 10 having the at least one latch mechanisms 20 discussed above and illustrated in FIGS. 1-9. Such locking cylinder 410 may be used with articulating boom 2 discussed above and other types of lifting booms mentioned herein.

In FIG. 17, locking cylinder 410 includes an inner tube 412 and an outer tube (not illustrated) that are substantially similar to inner tube 12 and outer tube 14 of locking cylinder 10 discussed previously. Locking cylinder 410 also includes a base 416 that is substantially similar to base 16 of locking cylinder 10 discussed previously. Locking cylinder 410 also includes at least one latch mechanism 420 that operably engages with the base 416 to automatically lock the outer tube and base 416 with inner tube 412 or to automatically unlock the outer tube and base 416 from inner tube 412 substantially similar to the automatic locking or unlocking procedures of latch mechanisms 20 discussed previously in locking cylinder 10. While a single latch mechanism 420 is illustrated for brevity, locking cylinder 410 may include a pair of latch mechanisms 420 similar to the pair of latch mechanisms 20 used in locking cylinder 10.

In this embodiment, latch mechanism 420 also includes a piston 422, a latch plate 424, a first biaser 426, and a retainer 428, that are substantially similar to piston 22, latch plate 24, biaser 26, and retainer 28 of each latch mechanism 20 of locking cylinder 10. In this embodiment, however, latch mechanism 420 also includes a second biaser 427 that operably engages with the piston 422 and latch plate 424 for biasing the piston 422 to the locked position (see FIG. 17). With this inclusion of second biaser 427, second biaser 427 is housed inside of the first biaser 426 in which the first biaser 426 and the second biaser 427 are coaxial with one another. As such, the first biaser 426 defines a first inner diameter that is greater than a second inner diameter defined by second biaser 427 to house the second biaser 427. Such dual-spring configuration may be desired depending on implementation of locking cylinder 410, including the type of mechanical load or fluid that is exerted on piston 422, the increase of biasing force on the piston 422, redundant biasing force applied to the piston 422 if one of the biasers 426, 427 fails.

Latch mechanism 420 also includes a seal ring 430 that different from the seal ring 30 of each latch mechanism 20 previously discussed. In this embodiment, seal ring 430 is a U-lip type seal ring 430 that operably engages with piston 422 to provide a fluid tight seal or airtight barrier between the piston 422 and at least one interior surface that defines a locking passageway of base 416 similar to the fluid tight seal or airtight barrier provided by seal ring 30 between the piston 22 and at least one interior surface that defines each locking passageway 16h of base 16 of locking cylinder 10. However, seal ring 430 may be chosen to be used in this embodiment, and other embodiments mentioned herein, when locking cylinder 510 actuates at low speeds in low pressure environments in various types of cylinders, including hydraulic and pneumatic cylinders.

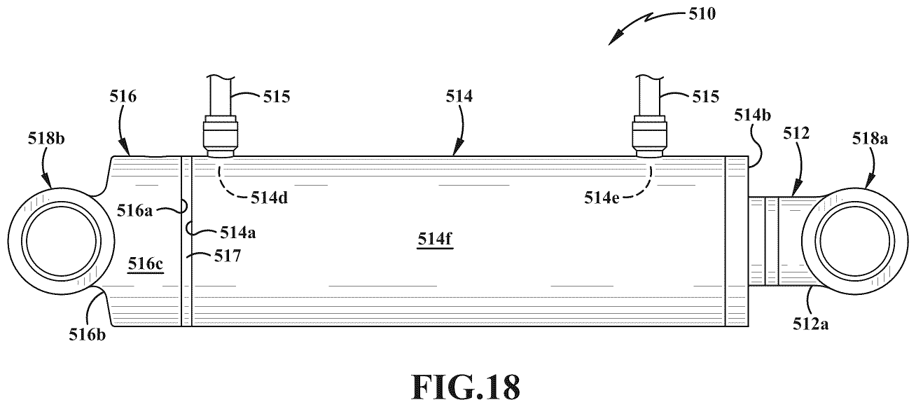

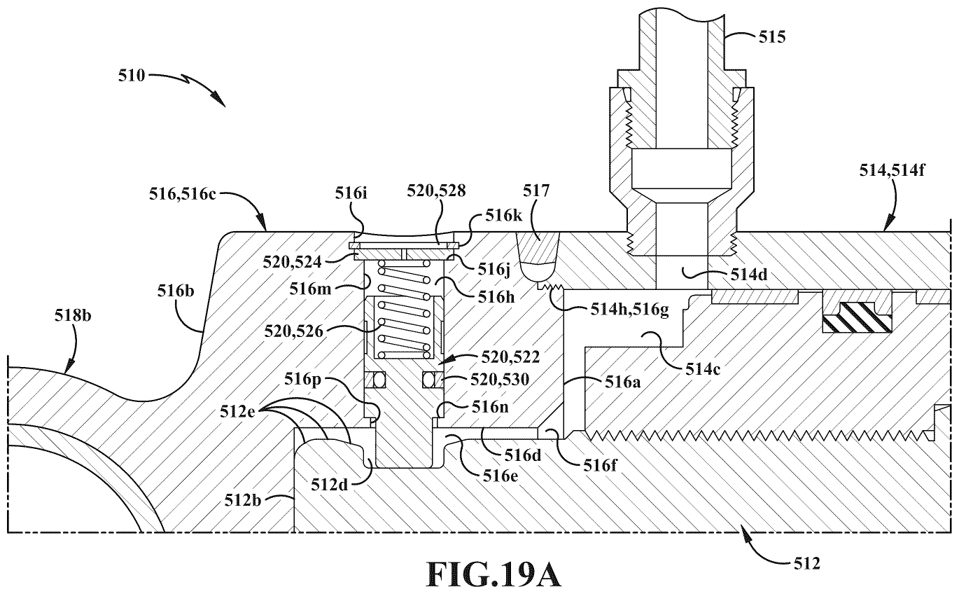

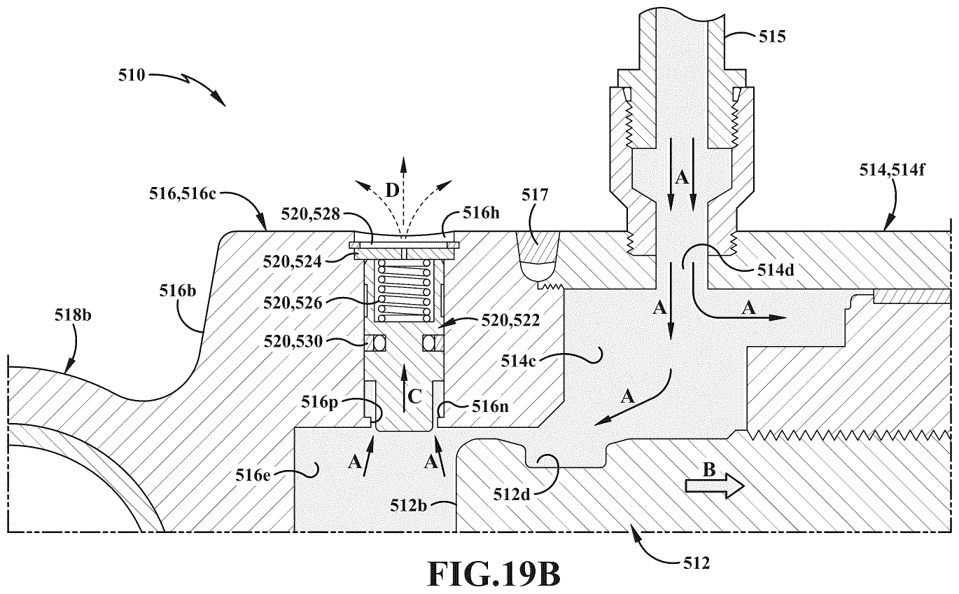

FIGS. 18-19B illustrate another locking cylinder or double-acting cylinder 500 that may be used for an articulating boom (such as articulating boom 2) or similar machine that requires expansion and retraction of force between two mechanical components. Such components of locking cylinder 500 are discussed in greater detail below.

In FIGS. 18 and 19A, locking cylinder 510 includes a first or inner tube 512. In the present disclosure, inner tube 512 includes a first end 512a, a second end 512b opposite to the first end 512a, and a longitudinal axis defined between the first end 512a and the second end 512b. As compared to inner tube 12 of locking cylinder 10, inner tube 512 is solid and is free from defining any longitudinal passageways or voids between the first end 512a and the second end 512b. Inner tube 512 also defines annular groove 512d that extends radially into the inner tube 512 at a location between the first end 512a and the second end 512b that is closer to the second end 512b. As discussed in greater detail below, annular groove 512d is configured to receive one or more latch mechanisms of locking cylinder 510 so that latch mechanisms of locking cylinder 510 lock inner tube 512 and an outer tube of locking cylinder 510 with one another.

Still referring to inner tube 512, inner tube 512 also includes a ramp 512e that extends longitudinally from the second end 512b and terminates at the annular groove 512d (see FIGS. 19A-19B). Similar to ramp 12e of inner tube 12, ramp 512e is configured to enable a piston of a latch mechanism of locking cylinder 510 to ride along the inner tube 512 so that piston may automatically lock the inner tube 512 and an outer tube of locking cylinder 510 with one another as locking cylinder 510 moves from an extended position (see FIG. 19B) to a retracted position (see FIG. 19A).

Locking cylinder 510 also includes a second or outer tube 514 that slidably engages with the inner tube 512 such that the outer tube 514 houses at least a portion of inner tube 512 extending from the second end 512b to a location between first and second end 512a, 512b of inner tube 512. In the present disclosure, outer tube 514 includes a first end 514a, a second end 514b that is opposite to the first end 514a, and a longitudinal axis defined between the first end 514a and the second end 514b. As best seen in FIGS. 19A-19B, outer tube 514 also defines an outer chamber 514c that extends along the longitudinal axis of outer tube 514 between first end 514a and second end 514b. It should be noted that second end 514b is an open end that provides access to outer chamber 514c while also being sealed and enabling inner tube 512 to slidably move into and out of outer chamber 514c when locking cylinder 510 is actuated between the retracted position and the extended position.

Outer tube 514 also defines an inlet 514d and an outlet 514e that allow a mechanical load (such as hydraulic fluid or air) to flow in and out of the outer chamber 514c of outer tube 514 for actuation purposes. As best seen in FIGS. 19A-19B, inlet 514d is defined proximate to the first end 514a of outer tube 514 and extends entirely through outer tube 514 between an exterior surface 514f of outer tube 514 that is in communication with the surrounding environment of locking cylinder 510 and an interior surface 514g of outer tube 514 that defines outer chamber 514c. Referring to FIG. 18, outlet 514e is defined proximate to the second end 514b of outer tube 514 and opposite to the inlet 514d. While not illustrated herein, outlet 514e extends entirely through outer tube 514 between exterior surface 514f of outer tube 514 and interior surface 514g of outer tube 514. Such inlet 514d and outlet 514e provide fluid communication between outer tube 514 and a mechanical load unit (such as a hydraulic pump or compressor) via mechanical load lines 515 secured to the outer tube 514 at inlet 514d and outlet 514e (see FIG. 18).

Locking cylinder 510 also includes a base 516 that operably engages with outer tube 514 and is configured to receive a portion of the inner tube 512 when the locking cylinder 10 is in the retracted position. As best seen in FIG. 19A, base 516 includes a first end 516a that operably engages with the outer tube 514, a second end 516b opposite to the first end 516a, and a longitudinal axis defined between the first end 516a and the second end 516b. Base 516 also includes an exterior surface 516c that extends between the first end 516a and the second end 516b and is in communication with the exterior environment surrounding the base 516. Base 516 also includes an interior surface 16d that extends between the first end 516a and the second end 516b and assists in defining an interior space or chamber 516e defined by the base 516. Chamber 516e of base 516 is also accessible from an opening 516f defined at first end 516a of base 516 that is configured to receive a portion of inner tube 512. Base 516 also defines an external threading 516h at the first end 516a to threadedly engage the base 516 with a threading 514d of outer tube 514; as such, base 516 is releasably engaged with the outer tube 514 for ease of repairing base 516 in isolation or to replace a used or damaged base 516 with a new or refurbished base 516. In this embodiment, a seal 517 (such as a gasket or O-ring) is positioned between the outer tube 514 and base 516 to provide a fluid tight or airtight barrier at the threaded connection between the outer tube 514 and base 516.

Still referring base 516, base 516 also defines at least one locking passageway 516h. As best seen in FIG. 19A, locking passageway 516h extends between the exterior surface 516c and the interior surface 516d along an axis that is non-parallel to or orthogonal to the longitudinal axis of base 516; as such, the exterior surface 516c and the interior surface 516d are in communication with one another at locking passageway 516h. It should be noted that locking passageway 516h also provides access to the chamber 516e in which the chamber 516e and the exterior environment surrounding the base 516 are in communication with one another at locking passageway 516h.

In FIG. 19A, locking passageway 516h is defined by a first lateral surface 516i of base 516 that extends from the exterior surface 516c to a first shoulder 516j and defines a first diameter. Base 516 also defines an internal notch 516k inside of the locking passageway 516h that is located along the first lateral surface 516i at a position between the exterior surface 516c and the first shoulder 516j. Locking passageway 516h is also defined by a second lateral surface 516m that extends from the first shoulder 516j to a second shoulder 516n and defines a second diameter that is less the first diameter of the first lateral surface 516i. Locking passageway 516h is also defined by a third lateral surface 516p that extends from the second shoulder 516n to the interior surface 516d of base 516 and defines a third diameter that is less the first and second diameters of the first lateral surface 516i and second lateral surface 516m. As discussed in greater detail below, base 516 is configured to receive and engage with a latch mechanism inside of each locking passageway of the pair of locking passageways 516h to automatically lock the outer tube 14 and base 16 with the inner tube 12 when a mechanical load is absent or to automatically unlock the outer tube 514 and base 516 with the inner tube 512 when a mechanical load is presented and applied to each latch mechanism.

Locking cylinder 510 also includes a pair of attachment rings or members 518a, 518b. As best seen in FIG. 18, inner tube 512 includes a first attachment ring 518a that is formed at the first end 512a of inner tube 512. Still referring to FIG. 18, base 516 includes a second attachment ring 518b that is formed at the second end 514b of outer tube 514. In operation, the attachment ring 518a, 518b provide attachment or securement points to allow two opposing components of a machine to engage with the inner tube 512 and base 516 at attachment ring 518a, 518b to move or actuate first and/or second components of the machine when locking cylinder 510 is actuated between the retracted position and the extended position.

Locking cylinder 510 also includes a latch mechanism 520. As best seen in FIGS. 19A-19B, latch mechanism 520 removably engages with the base 516 inside of locking passageway 516h and is engageable with the inner tube 512 between a locked position (see FIG. 19A) and an unlocked position (see FIG. 19B). In this embodiment, latch mechanism 520 includes a piston 522, a latch plate 524, a biaser 526, a retainer 528, and a seal ring 530 that are identical to the piston 22, latch plate 24, biaser 26, retainer 28, and seal ring 30 of each latch mechanism 20 of locking cylinder 10. As such, piston 522 is configured to be spring-biased by biaser 526 between a locked position to automatically lock the inner tube 512 with outer tube 514 and base 516 when the locking cylinder 510 is in the retracted or stored position (see FIG. 19A) and an unlocked position to automatically unlock inner tube 512 from outer tube 514 and base 516 when the locking cylinder 510 is in the expanded or operating position (see FIG. 19B).

It should be noted that while locking cylinder 510 is equipped with a single latch mechanism 520, any suitable number of latch mechanisms 520 may be equipped to locking cylinder 510 for locking the inner tube 512 with outer tube 514 and base 516. In one exemplary embodiment, locking cylinder 510 may include a first latch mechanism (like latch mechanism 520) that is secured to base 516 inside a first locking passageway (like locking passageway 516h) defined at a first position in base 516, and a second latch mechanism (like latch mechanism 520) that is secured to base 516 inside a second locking passageway (like locking passageway 516h) defined at a second position in base 516 that is vertically or transversely opposite to the first latch mechanism. In this exemplary embodiment, both latch mechanisms engage with the same annular groove (such as annular groove 512d) of inner tube 512 to lock the inner tube 512 with outer tube 514 and base 516. In another exemplary embodiment, locking cylinder 510 may include a first latch mechanism (like latch mechanism 520) that is secured to base 516 inside a first locking passageway (like locking passageway 516) defined at a first position in base 516, and a second latch mechanism (like latch mechanism 520) that is secured to outer tube 514 inside a second locking passageway (like locking passageway 516h) defined at a second position in outer tube 514 that is longitudinally opposite to the first latch mechanism. In this exemplary embodiment, latch mechanisms engage with separate annular grooves (such as annular groove 512d) of inner tube 512 to lock the inner tube 512 with outer tube 514 and base 516.

Having now discussed the components of locking cylinder 510, a method of actuating locking cylinder 510 from a retracted position to an extended position is discussed in greater detail below.

Initially, piston 522 of latch mechanism 520 remains seated inside of the annular groove 512d of inner tube 512 to lock inner tube 512 with outer tube 514 and base 516. Particularly, the biaser 526 applies a biasing force against piston 522 (as well as latch plate 524) to bias the piston 522 to the locked position until a mechanical load overcomes such biasing force.

As a mechanical load is introduced into the outer tube 514 and base 516 from inlet 514d, the mechanical load fills the outer chamber 514c of outer tube 514 and chamber 516e of base 516; such introduction of the mechanical load into the outer chamber 514c and chamber 516e of base 516 is denoted by arrows labeled “A” in FIG. 19B. Once the mechanical load is introduced into the outer tube 514 and base 516, the mechanical load escapes around the inner tube 512 past the annular groove 512d and interacts with the piston 522. At this stage, the mechanical load exerts a force against the piston 522 (similar to the force applied by mechanical load against the piston 22 of latch mechanism 20) to automatically move or actuate the piston 522 from the locked position to the unlocked position; such actuation of the piston 522 from the locked position to the unlocked position is denoted by an arrow labeled “B” in FIG. 19B. The piston 522 is automatically actuated to the unlocked position due to the mechanical load exerting a force that overcomes the biasing force applied by the biaser 526 thus compressing the biaser 526 inside of the piston 522. During this actuation, air trapped inside of piston 522 and locking passageway 516h exits through the latch plate 524 and into the exterior environment surrounding the locking cylinder 510 to reduce unwanted pressure inside of the locking passageway 516h; such release or escapement of the air trapped inside of piston 522 and locking passageway 516h is denoted by dashed arrows labeled “C” in FIG. 19B.

Once the piston 522 is removed from the annular groove 512d and is free from engaging the inner tube 512, inner tube 512 is free to be actuated from outside of the outer tube 514 and base 516 so that locking cylinder 510 may actuate from the retracted position to the extended position. Such actuation of the inner tube 512 inside of the outer tube 514 is denoted by an arrow labeled “D” in FIG. 19B.

When an operator of locking cylinder 510 desires to retract the inner tube 512 back into the outer tube 514, the mechanical load may be withdrawn through outlet 514e. Similar to piston 22 of latch mechanism 20, piston 522 may reengage with and lock the inner tube 512 with the outer tube 514 and base 516 automatically once the mechanical load is removed from the piston 522 and the piston 522 is reseated inside of the annular groove 512d of inner tube 512.

As discussed and illustrated herein, locking mechanisms, including latch mechanisms 20, 120, 220, 320, 420, 520, may experience a range of mechanical loads to automatically lock or unlock the particular locking cylinder. In one example, latch mechanisms discussed herein may experience mechanical loads up to about 500 pounds of force and are free from yielding from mechanicals loads less than 1,000 pounds of force. In this same example, latch mechanisms discussed herein are configured to unlatch or unlock a particular locking cylinder when subjected to a mechanical load of about 500 pounds of force.

As discussed above and illustrated herein, locking cylinders, including locking cylinders 10, 110, 210, 310, 410, 510, are equipped with at least one latching mechanisms, including latch mechanisms 20, 120, 220, 320, 420, 520, or a pair of latching mechanisms. In other exemplary embodiments, however, any locking cylinder discussed herein may include any suitable number of latching mechanisms to automatically lock or unlock a respective locking cylinder. Examples of suitable numbers of latching mechanisms that may be included with a locking cylinder mentioned herein includes at least one, two, a plurality, three, four, and other suitable numbers of latching mechanisms that may be included with a locking cylinder depending on the size, shape, and structural configuration of the respective locking cylinder.

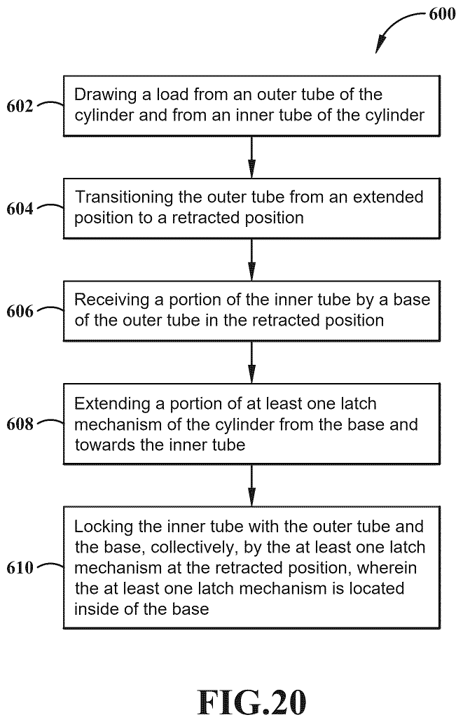

FIG. 20 illustrates a diagrammatic flowchart for a method 600 of locking a cylinder. An initial step 602 of method 600 includes drawing a load from an outer tube of the cylinder and from an inner tube of the cylinder. Another step 604 of method 600 includes transitioning the outer tube from an extended position to a retracted position. Another step 606 of method 600 includes receiving a portion of the inner tube by a base of the outer tube in the retracted position. Another step 608 of method 600 includes extending a portion of at least one latch mechanism of the cylinder from the base and towards the inner tube. Another step 610 of method 600 includes locking the inner tube with the outer tube and the base, collectively, by the at least one latch mechanism at the retracted position, wherein the at least one latch mechanism is located inside of the base.

In other exemplary embodiments, method 600 may include further steps or optional steps of locking a cylinder. In one exemplary embodiment, method 600 may further include that when the outer tube is in the retracted position, the at least one latch mechanism is free from being under load. In another exemplary embodiment, method 600 may further include that when the outer tube is in the extended position, the at least one latch mechanism is under load and is free from engaging with the inner tube. In another exemplary embodiment, method 600 may further include steps of: sliding the at least one latch mechanism along a ramp of the inner tube as the outer tube transitions from the extended position to the retracted position; and seating a piston of the at one latch mechanism inside of a groove defined in the inner tube. In another exemplary embodiment, method 600 may further include a step of: biasing the piston of the at one latch mechanism into the groove by a biaser of the at least one latch mechanism when the at least one latch mechanism is free from being under load. In another exemplary embodiment, method 600 may further include a step of: passing air through a retainer of the at least one latch mechanism and through the base when the outer tube moves between the retracted position and the extended position. In another exemplary embodiment, method 600 may further include that the at least one latch mechanism maintains the load inside of the outer tube and the base. In another exemplary embodiment, method 600 may further include that when the outer tube is in the retracted position, the at least one latch mechanism is free from being under a hydraulic load; and wherein when the outer tube is in the extended position, the at least one latch mechanism is under the hydraulic load and is free from engaging with the inner tube.

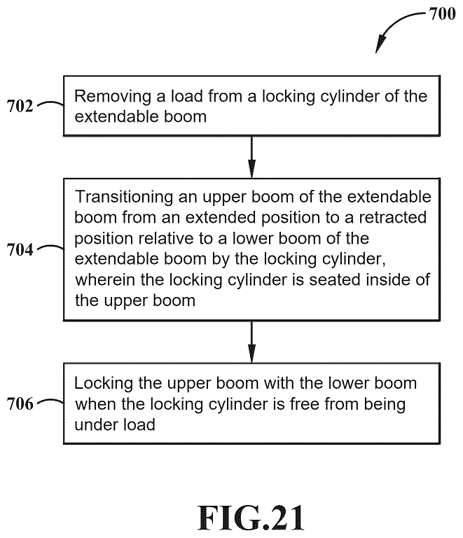

FIG. 21 illustrates a diagrammatic flowchart for a method 700 of operating an extendable boom for a lift vehicle. An initial step 702 of method 700 includes removing a load from a locking cylinder of the extendable boom. Another step 704 of method 700 includes transitioning an upper boom of the extendable boom from an extended position to a retracted position relative to a lower boom of the extendable boom by the locking cylinder, wherein the locking cylinder is seated inside of the upper boom. Another step 706 of method 700 includes locking the upper boom with the lower boom when the locking cylinder is free from being under load.

In other exemplary embodiments, method 700 may include further steps or optional steps of operating an extendable boom for a lift vehicle. In one exemplary embodiment, method 700 may further include that the step of locking the upper boom with the lower boom further comprises: providing at least one latch mechanism of the locking cylinder with a base of the locking cylinder; and locking the at least one latch mechanism with an inner tube of the locking cylinder inside of a groove defined by the inner tube. In another exemplary embodiment, method 700 may further include that when the upper boom is in the extended position, the at least one latch mechanism is under load and is free from engaging with the inner tube of the locking cylinder. In another exemplary embodiment, method 700 may further include steps of: sliding at least one latch mechanism along a ramp of the inner tube as the outer tube transitions from the extended position to the retracted position; and seating a piston of the at one latch mechanism inside of a groove defined in the inner tube. In another exemplary embodiment, method 700 may further include a step of: biasing the piston of the at one latch mechanism into the groove by a biaser of the at least one latch mechanism when the at least one latch mechanism is free from being under load. In another exemplary embodiment, method 700 may further include a step of: passing air through a retainer of the at least one latch mechanism and through the base when the outer tube moves between the retracted position and the extended position. In another exemplary embodiment, method 700 may further include that the at least one latch mechanism maintains the load inside of the outer tube and the base.

It should be understood that cylinders having latch or locking mechanisms mentioned herein, including cylinders 10, 110, 210, 310, 410, 510, are capable of experiencing and supporting a range of loads. In one exemplary embodiment, cylinder having latch mechanisms mentioned herein may experience and support loads of at least 500 pounds. In another exemplary embodiment, cylinder having latch mechanisms mentioned herein may experience and support loads between approximately 500 pounds up to approximately 1,000 pounds. Additionally, it should be understood that the latch mechanisms included in each cylinder mentioned herein, including cylinders 10, 110, 210, 310, 410, 510, unlatch or unlock at a desired load rating. In one exemplary embodiment, each latch mechanism included in each cylinder mentioned herein unlatches or unlocks when subjected to a load of approximately 500 pounds and the unlatching or unlocking pressure is applied. Furthermore, it should be understood that the latch mechanisms included in each cylinder mentioned herein, including cylinders 10, 110, 210, 310, 410, 510, may have a desired weight. In one exemplary embodiment, each latch mechanism included in each cylinder mentioned herein weighs less than five pounds.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the device the present disclosure is described as a complete unit within the present disclosure, it is to be understood that some of the components or features detailed herein can be supplied as a retrofit kit. This approach enables the provision of only certain parts necessary to upgrade a legacy device to the specifications of device of the present disclosure. Essentially, instead of requiring the replacement of the entire device, the retrofit kit allows for the selective enhancement of specific components. This could allow a user or operator to efficiently upgrade its/their existing legacy devices, systems, or assemblies to achieve the performance and functionality of the device of the present disclosure without a full replacement. In the event that a component or portion of the system of the present disclosure is provided as part of a retrofit kit, those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An extendable boom for a lift vehicle, comprising:
a lower boom operably engaged with the lift vehicle;
an upper boom slidably engaged with and housed inside of the lower boom; and
a locking cylinder nested inside of the upper boom configured to transition the upper boom between an operating position and a stored position relative to the lower boom;
wherein the locking cylinder is configured to lock the upper boom to the stored position when the locking cylinder is free from being under load.

2. The extendable boom of claim 1, wherein when the upper boom is in the stored position, at least one latch mechanism of the locking cylinder is free from being under the load exerted inside of the locking cylinder.

3. The extendable boom of claim 1, wherein when the upper boom is in the operating position, at least one latch mechanism of the locking cylinder is under the load exerted inside of the locking cylinder and is free from engaging with an inner tube of the locking cylinder.

4. The extendable boom of claim 1, wherein the locking cylinder comprises:
an inner tube;
an outer tube slideably engaged with the inner tube between a retracted position and an extended position;
a base removably engaged with the outer tube and is in communication with the inner tube to partially receive the inner tube in the retracted position; and
at least one latch mechanism is configured to lock the inner tube with the base and the outer tube, collectively, at the retracted position.

5. The extendable boom of claim 4, wherein the at least one latch mechanism further comprises:
a piston moveably engageable inside the base between a locked position and an unlocked position relative to the inner tube;
a biaser operably engaging with the piston to bias the piston to the locked position; and
a retainer operably engaging with the biaser and the base for retaining the biaser and the piston inside of the base.

6. The extendable boom of claim 5, wherein the piston comprises:
a locking end operably engageable with the inner tube;
a non-locking end opposite to the locking end and operably engages with the biaser; and
a shoulder positioned between the locking end and the non-locking end to engage with the base when the piston locks the inner tube with the outer tube and the base, collectively.

7. The extendable boom of claim 6, wherein the non-locking end engages with and is housed inside of the biaser.

8. The extendable boom of claim 6, wherein the piston further comprises:
a cavity defined between the non-locking end and a base surface of the piston that is positioned between the locking end and the non-locking end and configured to engage with the biaser;
wherein the cavity is configured to house a portion of the biaser.

9. The extendable boom of claim 5, wherein the at least one latch mechanism further comprises:
an annular channel defined in the piston at a position between the locking end and non-locking end; and
a seal operably engaging with the piston inside of the annular channel and with an internal wall of the base inside of the at least one locking passageway.

10. The extendable boom of claim 5, wherein the at least one latch mechanism further comprises:
a first end of a latch plate operably engaging with the retainer;
a second end of the latch plate operably engaging with the biaser; and
a passage defined between the first end and the second end and is in fluid communication with the at least one locking passageway of the base.

11. The extendable boom of claim 4, wherein the at least one latch mechanism comprises:
a piston moveably engageable inside of the base between a locked position and an unlocked position relative to the inner tube;
a first biaser operably engaging with the piston to bias the piston to the locked position;
a second biaser operably engaging with the piston to bias the piston to the locked position and housed inside of the first biaser; and
a retainer operably engaging with the first biaser, the second biaser, and the base for retaining the first biaser, the second biaser, and the piston inside of the base.

12. The extendable boom of claim 4, wherein the inner tube comprises:
a first end;
a second end opposite to the first end and housed inside of the base when the outer tube and the base, collectively, are at the retracted position;
an annular groove defined between the first end and the second end; and
a ramp extending from the second end to the annular groove;
wherein a piston of the at least one latch mechanism is configured to ride along the ramp and engage with the inner tube inside of the annular groove when the outer tube translates from the extended position to the retracted position.

13. The extendable boom of claim 4, wherein when the outer tube is in the retracted position, the at least one latch mechanism is free from being under a hydraulic load; and
wherein when the outer tube is in the extended position, the at least one latch mechanism is under the hydraulic load and is free from engaging with the inner tube.

14. A method of operating an extendable boom for a lift vehicle, comprising:
removing a load from a locking cylinder of the extendable boom;
transitioning an upper boom of the extendable boom from an extended position to a retracted position relative to a lower boom of the extendable boom by the locking cylinder, wherein the locking cylinder is seated inside of the upper boom;
locking the upper boom with the lower boom when the locking cylinder is free from being under load.

15. The method of claim 14, wherein the step of locking the upper boom with the lower boom further comprises:
providing at least one latch mechanism of the locking cylinder with a base of the locking cylinder; and
locking the at least one latch mechanism with an inner tube of the locking cylinder inside of a groove defined by the inner tube.

16. The method of claim 15, wherein when the upper boom is in the extended position, the at least one latch mechanism is under load and is free from engaging with the inner tube of the locking cylinder.

17. The method of claim 15, further comprising:
sliding at least one latch mechanism along a ramp of the inner tube as the outer tube transitions from the extended position to the retracted position; and
seating a piston of the at one latch mechanism inside of a groove defined in the inner tube.

18. The method of claim 17, further comprising:
biasing the piston of the at one latch mechanism into the groove by a biaser of the at least one latch mechanism when the at least one latch mechanism is free from being under load.

19. The method of claim 15, further comprising:
passing air through a retainer of the at least one latch mechanism and through the base when the outer tube moves between the retracted position and the extended position.

20. The method of claim 15, wherein the at least one latch mechanism maintains the load inside of the outer tube and the base.
